(19) United States
(12) Patent Application Publication
(10) Pub. No.: US 2022/0217722 A1
(43) Pub. Date: Jul. 7, 2022

(54) Wireless Operation in a Cell with Licensed and Unlicensed Carriers

(71) Applicant: Telefonaktiebolaget LM Ericsson (publ), Stockholm (SE)

(72) Inventor: Min Wang, Luleå (SE)

(21) Appl. No.: 17/608,191

(22) PCT Filed: Apr. 27, 2020
(86) PCT No.: PCT/EP2020/061650

§ 371 Date: Nov. 2, 2021

Related U.S. Application Data
(60) Provisional application No. 62/842,284, filed on May 2, 2019.

(51) Int. Cl. H04W 72/04; H04W 74/08; H04W 16/14; H04W 72/02; H04W 72/08; H04W 36/08

(52) U.S. Cl. CPC H04W 72/0453; H04W 74/0808; H04W 36/08; H04W 72/02; H04W 72/085; H04W 16/14

(57) ABSTRACT

A wireless device (12) obtains a measure of channel occupancy within and/or clear channel assessment failure within an unlicensed frequency band within which an unlicensed uplink carrier (16U) of a cell (14) is deployed. Based on the obtained measure, the wireless device (12) selects, from among the unlicensed uplink carrier (16U) of the cell (14) and a licensed uplink carrier (16L) of the cell (14), an uplink carrier on which to perform one or more uplink transmissions. The wireless device (12) performs the one or more uplink transmissions on the selected uplink carrier.

### TECHNICAL FIELD

The present application relates generally to wireless communication, and relates more particularly to wireless operation in a cell with licensed and unlicensed carriers.

### BACKGROUND

A New Radio (NR) cell uses an NR downlink carrier and an NR uplink (NUL) carrier that are each deployed at a relatively high carrier frequency. Whereas coverage loss attributable to the high carrier frequency may be compensated on the NR downlink carrier by power boosting, restrictions on wireless device power, antenna size, and/or cost prevent similar compensation on the NUL carrier. Instead, the NUL carrier may be supplemented by a supplementary uplink (SUL) carrier, which may be deployed at a lower carrier frequency and therefore have better coverage. A wireless device may then use whichever of the NUL carrier and the SUL carrier has the better channel quality.

Supplementing the NUL carrier with an SUL carrier proves complicated, however, when the NUL carrier is deployed in an unlicensed frequency band. In this case, the wireless device's actual use of the NUL carrier may be conditional on the wireless device successfully clearing the NUL carrier for use, e.g., via a listen-before-talk (LBT) procedure. Challenges exist, then, in how to account for the unlicensed nature of the NUL carrier's deployment when choosing which uplink carrier the wireless device should use, especially in a way that provides fast carrier switching and/or that maintains network control over the switch decision.

### SUMMARY

Some embodiments herein facilitate selection between an unlicensed uplink carrier (e.g., NUL carrier) of a cell and a licensed uplink carrier (e.g., SUL carrier) of the cell, in a way that accounts for the unlicensed nature of the unlicensed uplink carrier's deployment. Some embodiments for example facilitate selection between the carriers based on channel occupancy within and/or clear channel assessment failure within an unlicensed frequency band within which the unlicensed uplink carrier is deployed, e.g., in addition to or alternatively to being based on channel quality on the unlicensed uplink carrier. This way, for instance, the licensed uplink carrier may be selected if consistent listen-before-talk (LBT) problems are detected on the unlicensed uplink carrier. For example, in some embodiments, the licensed uplink carrier is selected if the channel occupancy within and/or clear channel assessment failure within the unlicensed frequency band is higher than a threshold, e.g., even if the channel quality of the unlicensed uplink carrier is acceptable.

More particularly, in some embodiments, the wireless device or a network node selects between the unlicensed uplink carrier and the licensed uplink carrier based on the channel occupancy within and/or clear channel assessment failure within the unlicensed frequency band. Alternatively or additionally, the wireless device in some embodiments transmits, to a radio network node serving the cell, a request to perform the one or more uplink transmissions on the selected uplink carrier. The request may for instance take the form of a request to switch from the unlicensed uplink carrier of the cell to the licensed uplink carrier of the cell. In still other embodiments, the wireless device may transmit a report to a network node indicating information about the channel occupancy within and/or clear channel assessment failure within the unlicensed frequency band. The report may for instance indicate the occurrence of an event based on the channel occupancy within and/or clear channel assessment failure within the unlicensed frequency band.

More specifically, embodiments herein include a method performed by a wireless device. The method comprises obtaining a measure of channel occupancy within and/or clear channel assessment failure within an unlicensed frequency band within which an unlicensed uplink carrier of a cell is deployed. The method further comprises selecting, from among the unlicensed uplink carrier of the cell and a licensed uplink carrier of the cell, an uplink carrier on which to perform one or more uplink transmissions, based on the obtained measure. The method also comprises performing the one or more uplink transmissions on the selected uplink carrier.

In some embodiments, said selecting comprises selecting the licensed uplink carrier if the obtained measure is greater than an occupancy or failure threshold.

In some embodiments, said selecting is further based on a channel quality metric for the unlicensed frequency band. In this case, said selecting may comprise selecting the licensed uplink carrier or the unlicensed uplink carrier depending respectively on whether: the channel quality metric is less than a quality threshold or the obtained measure is greater than an occupancy or failure threshold; or the channel quality metric is greater than the quality threshold and the obtained measure is less than the occupancy or failure threshold. In one such embodiment, the method further comprises receiving signaling indicating the occupancy or failure threshold, wherein the signaling is received in a handover command that commands the wireless device to hand over to the cell.

In some embodiments, the obtained measure is a function of: a ratio of failed clear channel assessments to total clear channel assessments; a number of consecutive clear channel assessment failures; and/or a level of channel occupancy.

In some embodiments, the obtained measure is per channel, subband, or bandwidth part within the unlicensed frequency band such that the obtained measure comprises, for each channel, subband, or bandwidth part of the unlicensed uplink carrier, a measure of channel occupancy on and/or clear channel assessment failure on that channel, subband, or bandwidth part. In this case, said selecting may comprise selecting the licensed uplink carrier if the obtained measure for each channel, subband, or bandwidth part of the unlicensed uplink carrier is greater than the occupancy or failure threshold.

In some embodiments, the measure is a function of a measure of channel occupancy on and/or clear channel assessment failure on the unlicensed uplink carrier or on an unlicensed downlink carrier deployed within the unlicensed frequency band.

In some embodiments, the measure is a function of: a duration between when an uplink or downlink transmission is triggered at a medium access control, MAC, protocol layer and when the uplink or downlink transmission is transmitted at a physical protocol layer; or a duration since the wireless device last detected a downlink reference signal in the cell.

In some embodiments, the method further comprises receiving signaling indicating the wireless device is to or is allowed to perform the one or more uplink transmissions on the unlicensed uplink carrier, wherein the signaling also indicates that the wireless device is allowed to instead perform the one or more uplink transmissions on the licensed uplink carrier if one or more conditions are fulfilled.

In some embodiments, the method further comprises transmitting, to a radio network node serving the cell, a request to perform the one or more uplink transmissions on the selected uplink carrier. In this case, said performing may comprise performing the one or more uplink transmissions on the selected uplink carrier responsive to receiving a response that grants the request. In one embodiment, transmitting the request comprises transmitting: a sounding reference signal on the licensed uplink carrier; a physical uplink control channel transmission on the licensed uplink carrier; a random access transmission on the licensed uplink carrier; a medium access control, MAC, control element, CE, on the licensed uplink carrier; or a radio resource control, RRC, message on the licensed uplink carrier.

In some embodiments, the method further comprises transmitting, to a network node, a report that indicates the obtained measure and/or that indicates occurrence of an event based on the obtained measure.

In some embodiments, the method further comprises, for each channel, subband, or bandwidth part of the unlicensed uplink carrier, obtaining a measure of channel occupancy on and/or clear channel assessment failure on that channel, subband, or bandwidth part. In one such embodiment, based on the measure of channel occupancy on and/or clear channel assessment failure on each channel, subband, or bandwidth part, the method further comprises selecting a channel, subband, or bandwidth part on which to perform one or more uplink transmissions; and performing one or more uplink transmissions on the selected channel, subband, or bandwidth part.

In some embodiments, the unlicensed uplink carrier is a New Radio, NR, unlicensed uplink carrier, and wherein the licensed uplink carrier is a supplementary uplink carrier.

Embodiments herein also include a method performed by a network node. The method comprises obtaining a measure of channel occupancy within and/or clear channel assessment failure within an unlicensed frequency band within which an unlicensed uplink carrier is deployed. The method also comprises selecting, from among the unlicensed uplink carrier of the cell and a licensed uplink carrier of the cell, an uplink carrier on which a wireless device is to perform one or more uplink transmissions, based on the obtained measure. The method further comprises transmitting, to the wireless device, signaling indicating the selected uplink carrier on which the wireless device is to perform the one or more uplink transmissions.

In some embodiments, said selecting comprises selecting the licensed uplink carrier if the obtained measure is greater than an occupancy or failure threshold.

In some embodiments, said selecting is further based on a channel quality metric for the unlicensed frequency band, and said selecting comprises selecting the licensed uplink carrier or the unlicensed uplink carrier depending respectively on whether: the channel quality metric is less than a quality threshold or the obtained measure is greater than an occupancy or failure threshold; or the channel quality metric is greater than the quality threshold and the obtained measure is less than the occupancy or failure threshold.

In some embodiments, the obtained measure is a function of: a ratio of failed clear channel assessments to total clear channel assessments; a number of consecutive clear channel assessment failures; and/or a level of channel occupancy.

In some embodiments, the obtained measure is per channel, subband, or bandwidth part within the unlicensed frequency band such that the obtained measure comprises, for each channel, subband, or bandwidth part of the unlicensed uplink carrier, a measure of channel occupancy on and/or clear channel assessment failure on that channel, subband, or bandwidth part. In this case, said selecting may comprise selecting the licensed uplink carrier if the obtained measure for each channel, subband, or bandwidth part of the unlicensed uplink carrier is greater than the occupancy or failure threshold.

In some embodiments, the measure is a function of a measure of channel occupancy on and/or clear channel assessment failure on the unlicensed uplink carrier or on an unlicensed downlink carrier deployed within the unlicensed frequency band.

In some embodiments, the measure is a function of: a duration between when an uplink or downlink transmission is triggered at a medium access control, MAC, protocol layer and when the uplink or downlink transmission is transmitted at a physical protocol layer; or a duration since the wireless device last detected a downlink reference signal in the cell.

In some embodiments, the method further comprises transmitting signaling indicating the wireless device is to or is allowed to perform the one or more uplink transmissions on the unlicensed uplink carrier, where the signaling also indicates that the wireless device is allowed to instead perform the one or more uplink transmissions on the licensed uplink carrier if one or more conditions are fulfilled.

In some embodiments, the method further comprises receiving, from the wireless device, a request to perform the one or more uplink transmissions on the licensed uplink carrier or the unlicensed uplink carrier, and said selecting is performed responsive to receiving the request. In one embodiment, receiving the request comprises receiving: a sounding reference signal on the licensed uplink carrier; a physical uplink control channel transmission on the licensed uplink carrier; a random access transmission on the licensed uplink carrier; a medium access control, MAC, control element, CE, on the licensed uplink carrier; or a radio resource control, RRC, message on the licensed uplink carrier.

In some embodiments, the method further comprises receiving, from the wireless device, a report that indicates the obtained measure and/or that indicates occurrence of an event based on the obtained measure.

In some embodiments, the method further comprises, for each channel, subband, or bandwidth part of the unlicensed uplink carrier, obtaining a measure of channel occupancy on and/or clear channel assessment failure on that channel, subband, or bandwidth part. The method may also comprise, based on the measure of channel occupancy on and/or clear channel assessment failure on each channel, subband, or bandwidth part, selecting a channel, subband, or bandwidth part on which the wireless device is to perform one or more uplink transmissions. The method may further comprise transmitting, to the wireless device, signaling indicating the selected channel, subband, or bandwidth part on which the wireless device is to perform the one or more uplink transmissions.

In some embodiments, the unlicensed uplink carrier is a New Radio, NR, unlicensed uplink carrier, and the licensed uplink carrier is a supplementary uplink carrier.

Embodiments herein also include corresponding apparatus, computer programs, and carriers of those computer programs. For example, embodiments herein include a wireless device, e.g., comprising communication circuitry and processing circuitry. The wireless device is configured to obtain a measure of channel occupancy within and/or clear channel assessment failure within an unlicensed frequency band within which an unlicensed uplink carrier of a cell is deployed. The wireless device is further configured to select, from among the unlicensed uplink carrier of the cell and a licensed uplink carrier of the cell, an uplink carrier on which to perform one or more uplink transmissions, based on the obtained measure. The wireless device is also configured to perform the one or more uplink transmissions on the selected uplink carrier.

Embodiments furthermore include a network node, e.g., comprising communication circuitry and processing circuitry. The network node is configured to obtain a measure of channel occupancy within and/or clear channel assessment failure within an unlicensed frequency band within which an unlicensed uplink carrier is deployed. The network node is also configured to select, from among the unlicensed uplink carrier of the cell and a licensed uplink carrier of the cell, an uplink carrier on which a wireless device is to perform one or more uplink transmissions, based on the obtained measure. The network node is further configured to transmit, to the wireless device, signaling indicating the selected uplink carrier on which the wireless device is to perform the one or more uplink transmissions.

### BRIEF DESCRIPTION OF THE DRAWINGS

FIG. 1 is a block diagram of a wireless communication system according to some embodiments.

FIG. 2 is a block diagram of a wireless communication system according to other embodiments.

FIG. 3 is a block diagram of a wireless communication system according to still other embodiments.

FIG. 4 is a logic flow diagram of a method performed by a wireless device according to some embodiments.

FIG. 5 is a logic flow diagram of a method performed by a network node according to some embodiments.

FIG. 6 is a logic flow diagram of a method performed by a wireless device according to other embodiments.

FIG. 7 is a logic flow diagram of a method performed by a network node according to other embodiments.

FIG. 8 is a logic flow diagram of a method performed by a wireless device according to yet other embodiments.

FIG. 9 is a logic flow diagram of a method performed by a network node according to yet other embodiments.

FIG. 10 is a block diagram of a wireless device according to some embodiments.

FIG. 11 is a block diagram of a network node according to some embodiments.

FIG. 12 is a block diagram of coverages of a New Radio uplink carrier (NUL) and a supplemental uplink carrier (SUL) in a New Radio cell according to some embodiments.

FIG. 13 is a block diagram of a wireless communication network according to some embodiments.

FIG. 14 is a block diagram of a user equipment according to some embodiments.

FIG. 15 is a block diagram of a virtualization environment according to some embodiments.

FIG. 16 is a block diagram of a communication network with a host computer according to some embodiments.

FIG. 17 is a block diagram of a host computer according to some embodiments.

FIG. 18 is a flowchart illustrating a method implemented in a communication system, in accordance with one embodiment.

FIG. 19 is a flowchart illustrating a method implemented in a communication system, in accordance with one embodiment.

FIG. 20 is a flowchart illustrating a method implemented in a communication system, in accordance with one embodiment.

FIG. 21 is a flowchart illustrating a method implemented in a communication system, in accordance with one embodiment.

### DETAILED DESCRIPTION

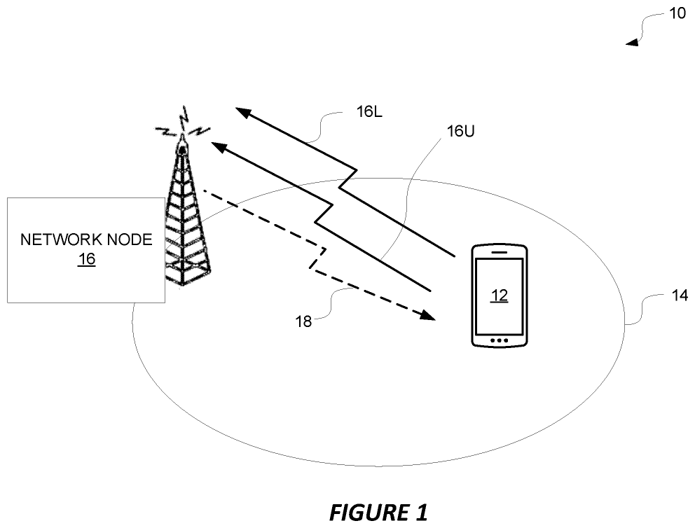

FIG. 1 shows a wireless communication system 10 according to some embodiments. The system 10 in some embodiments is a New Radio (NR) system. The system 10 includes a wireless device 12, e.g., a user equipment (UE). The wireless device 12 is shown as being served by a cell 14 provided by a network node 16 (e.g., a base station).

The wireless device 12 is configured to perform uplink transmission(s) in the cell 14. The uplink transmission(s) may for instance be one or more transmissions of a random access procedure, a physical uplink shared channel, or a physical uplink control channel. Regardless, the wireless device 12 is configured to perform the uplink transmission(s) on any of multiple uplink carriers, including a licensed uplink carrier 16L deployed within a licensed frequency band and an unlicensed uplink carrier 16U deployed within an unlicensed frequency band. That is, both the licensed uplink carrier 16L and the unlicensed uplink carrier 16U are carriers of the same cell. And the wireless device 12 is capable of using either of the uplink carriers 16U, 16L to perform uplink transmission. The unlicensed frequency band is a frequency band within which transmissions may be performed without a license from a licensor (which may be a regulatory or governing entity, e.g., the United States Federal Communications Commission, FCC, or the International Telecommunication Union, ITU). In some embodiments, the unlicensed frequency band is higher in frequency than the licensed frequency band, e.g., such that the licensed uplink carrier 16L has less coverage loss. In some embodiments where the cell 14 is an NR cell, the unlicensed uplink carrier 16U may be an NR uplink (NUL) carrier and the licensed uplink carrier 16L may be a supplementary uplink (SUL) carrier.

The wireless device 12 may also be configured to perform downlink transmission in the cell 14 on a downlink carrier 18. In some embodiments, the downlink carrier 18 is also deployed within the unlicensed frequency band.

Some embodiments herein facilitate selection between the unlicensed uplink carrier 16U of the cell 14 and the licensed uplink carrier 16L of the cell 14, e.g., in a way that accounts for the unlicensed nature of the unlicensed uplink carrier's deployment. Some embodiments for example facilitate selection between the carriers 16L, 16U based on channel occupancy within and/or clear channel assessment failure within the unlicensed frequency band within which the unlicensed uplink carrier 16U is deployed, e.g., in addition to or alternatively to being based on channel quality on the unlicensed uplink carrier 16U. This way, for instance, the licensed uplink carrier 16L may be selected if consistent listen-before-talk (LBT) problems are detected on the unlicensed uplink carrier 16U. For example, in some embodiments, the licensed uplink carrier 16L is selected if the channel occupancy within and/or clear channel assessment failure within the unlicensed frequency band is higher than a threshold, e.g., even if the channel quality of the unlicensed uplink carrier 16U is acceptable.

For example, consistent LBT failure may occur on the unlicensed uplink carrier 16U when LBT failures happen consistently on the unlicensed uplink carrier 16U. Here, an LBT failure may happen when the LBT procedure, that the wireless device 12 performs as a prerequisite to an uplink transmission, fails, i.e., because the channel is detected as already occupied. In some embodiments, the UL LBT failures that contribute to the wireless device 12 detecting consistent UL LBT failure include UL LBT failures for any type of uplink transmission, e.g., including multiple different types such as a sounding reference signal transmission, a control channel transmission, a data channel transmission, and/or a random access channel transmission.

More particularly in this regard, consistent UL LBT failure monitoring may employ the use of a timer and a counter. The timer may be referred to as an UL LBT failure counter, and the timer may be referred to as the inter-failure duration timer. The wireless device 12 may use the UL LBT failure counter to count the number of UL LBT failures that occur, e.g., across all types of uplink transmissions. The wireless device 12 may use the inter-failure duration timer to reset the counter when the UL LBT failures are not consistent, e.g., when no UL LBT failure occurs for at least a threshold amount of time. If or when the UL LBT failure counter reaches a threshold, the wireless device 12 may consider itself as having detected consistent LBT failure on the unlicensed uplink carrier 16U.

Alternatively or additionally, the licensed uplink carrier 16L may be selected if (i) a channel quality metric for the unlicensed frequency band (e.g., reference signal received power of a downlink pathloss reference) is less than a quality threshold; or (ii) a measure of the channel occupancy and/or clear channel assessment failure is greater than an occupancy or failure threshold. This measure may for instance be a function of: (i) a ratio of failed clear channel assessments to total clear channel assessments; (ii) a number of consecutive clear channel assessment failures; and/or (iii) a level of channel occupancy. Regardless, the unlicensed uplink carrier 16U in this case may correspondingly be selected if (i) the channel quality metric for the unlicensed frequency band is greater than the quality threshold; and (ii) the measure of the channel occupancy and/or clear channel assessment failure is less than the occupancy or failure threshold.

In some embodiments, the wireless device 12 itself autonomously performs the selection between the unlicensed uplink carrier 16U and the licensed uplink carrier 16L in this way. The wireless device 12 may do so for instance based on criteria and/or thresholds that are predefined or that are configured by the network node 16. The network node 16 may for instance configure the quality threshold and/or the occupancy or failure threshold, e.g., by signaling the threshold(s) such as within a handover command.

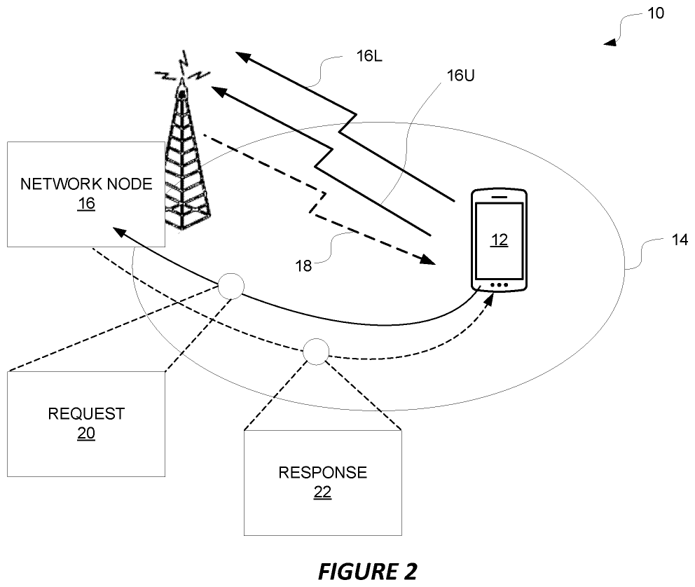

In other embodiments shown in FIG. 2, by contrast, the wireless device 12 performs the selection in this way, but it is conditioned on receiving approval from the network node 12 to perform the switch. In this case, then, the wireless device 12 may select which carrier to use for uplink transmission and transmit a request 20 to the network node 12 requesting permission to switch to or otherwise use the selected carrier.

In some embodiments, the request 20 may be an explicit request, e.g., with one or more bits explicitly representing such a request. In other embodiments, the request 20 is an implicit request. In these and other embodiments, for instance, the request 20 may be made by the wireless device 12 transmitting a sounding reference signal (SRR), a physical uplink control channel (PUCCH) transmission, a random access transmission (e.g., a preamble), a medium access control (MAC) control element (CE), or a radio resource control (RRC) message on the licensed uplink carrier 16L.

Regardless, the wireless device 12 may then perform uplink transmission(s) on the selected uplink carrier, responsive to receiving a response 22 that approves of the device's request. Or, the wireless device 12 may perform uplink transmission(s) on a carrier other than the selected uplink carrier, if the response 22 denies the device's request or if no response 22 is received.

In these and other embodiments, the network node 16 advantageously retains at least some control over the uplink carrier used by the wireless device 12 for uplink transmission, e.g., via configuration of criteria/thresholds for autonomous selection by the device 12 or via approval of carrier switch requests by the device 12. Yet the decision as to which uplink carrier to use or switch to accounts for the unlicensed nature of the unlicensed uplink carrier 16U, since the decision is made by the wireless device 12 on the basis of the device's knowledge of the channel occupancy and/or clear channel assessment failure within the unlicensed frequency band.

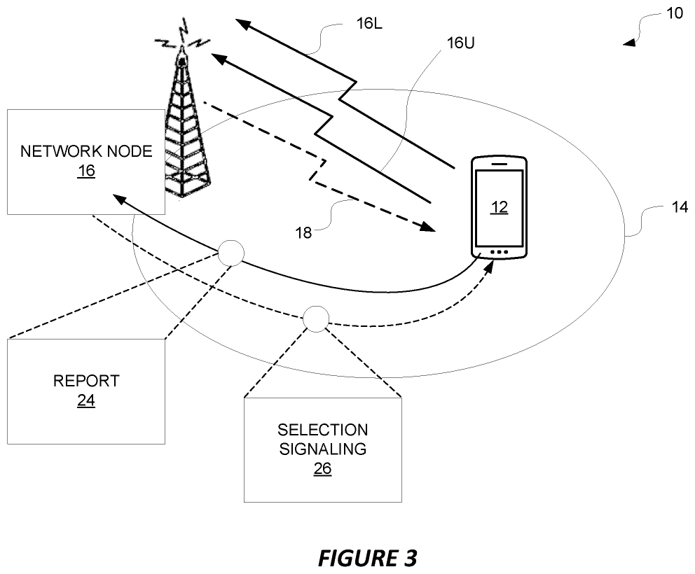

FIG. 3 shows yet other embodiments for facilitating selection between the carriers 16L, 16U in a way that may be implemented in combination with the embodiments show in FIG. 2 or separate therefrom. In these embodiments, the wireless device 12 transmits a report 24, e.g., on the licensed uplink carrier 16L. The report 24 indicates information about the channel occupancy within and/or clear channel assessment failure within the unlicensed frequency band within which the unlicensed uplink carrier 16U of the cell 14 is deployed. The report 24 may for instance indicate a measure of the channel occupancy within and/or clear channel assessment failure within the unlicensed frequency band. Alternatively or additionally, the report 24 may indicate occurrence of an event based on the measure of the channel occupancy within and/or clear channel assessment failure within the unlicensed frequency band. For example, the report 24 may indicate the occurrence of an event, where the event comprises the measure of the channel occupancy within and/or clear channel assessment failure within the unlicensed frequency band exceeding an occupancy or failure threshold.

No matter the particular content of the report 24, in some embodiments the network node 16 selects between the carriers 16L, 16U based on the report 24. Alternatively or additionally, the network node 16 may select a channel, subband, bandwidth part, or uplink carrier on which the wireless device 12 is to perform one or more uplink transmissions, based on the report 24 and/or based on the channel occupancy within and/or clear channel assessment failure within the unlicensed frequency band. The network node 16 in these cases may then transmit selection signaling 26 to the wireless device 12 indicating the selected channel, subband, bandwidth part, or uplink carrier on which the wireless device 12 is to perform one or more uplink transmissions. The selection signaling 26 may for instance be downlink control information (DCI).

In other embodiments, though, the wireless device 12 may transmit the report 24 to the network node 16 in conjunction with transmitting the request 20 of FIG. 2. In this case, the network node 16 may decide whether to grant or deny the request 20 based at least in part on the report 24.

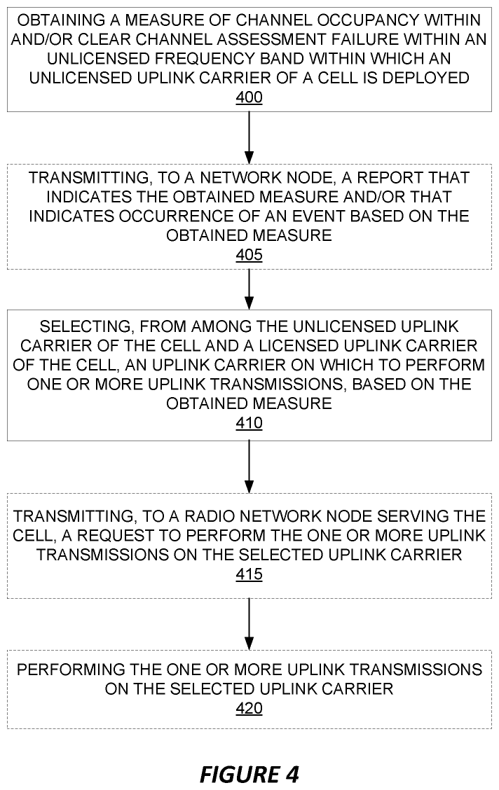

In view of the above modifications and variations, FIG. 4 depicts a method performed by a wireless device in accordance with particular embodiments. The method includes obtaining a measure of channel occupancy within and/or clear channel assessment failure within an unlicensed frequency band within which an unlicensed uplink carrier of a cell is deployed (Block 400). The method also includes selecting, from among the unlicensed uplink carrier of the cell and a licensed uplink carrier of the cell, an uplink carrier on which to perform one or more uplink transmissions, based on the obtained measure (Block 410). The method as shown in some embodiments further includes performing the one or more uplink transmissions on the selected uplink carrier (Block 420).

In some embodiments, the method also comprises transmitting, to a radio network node serving the cell, a request to perform the one or more uplink transmissions on the selected uplink carrier (Block 415). In this case, the method may comprise performing the one or more uplink transmissions on the selected uplink carrier responsive to receiving a response that grants the request.

Alternatively or additionally, the method in some embodiments includes transmitting, to a network node, a report that indicates the obtained measure and/or that indicates occurrence of an event based on the obtained measure (Block 405). The report may be transmitted on the licensed uplink carrier.

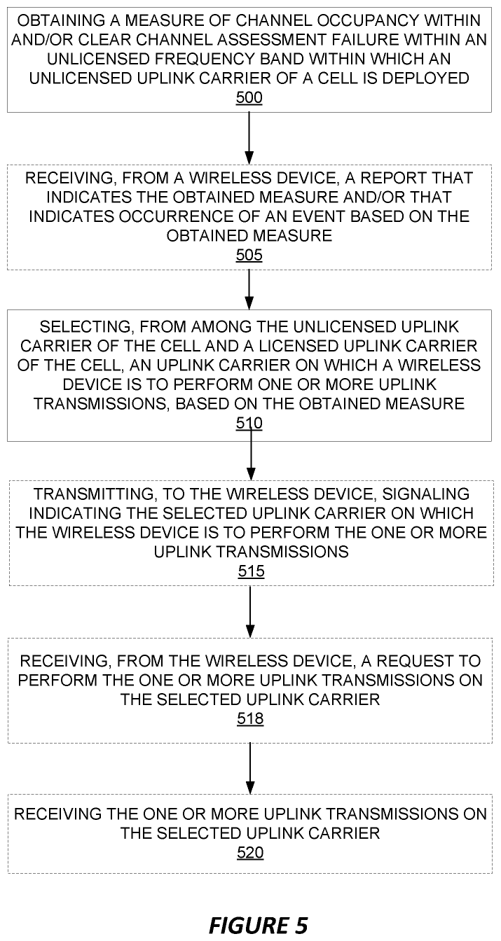

FIG. 5 depicts a method performed by a network node in accordance with other particular embodiments. The method includes obtaining a measure of channel occupancy within and/or clear channel assessment failure within an unlicensed frequency band within which an unlicensed uplink carrier is deployed (Block 500). The method also includes selecting, from among the unlicensed uplink carrier of the cell and a licensed uplink carrier of the cell, an uplink carrier on which a wireless device is to perform one or more uplink transmissions, based on the obtained measure (Block 510). In some embodiments, the method further includes transmitting, to the wireless device, signaling indicating the selected uplink carrier on which the wireless device is to perform the one or more uplink transmissions (Block 520).

In one or more embodiments, the method includes transmitting signaling indicating the wireless device is to or is allowed to perform the one or more uplink transmissions on the unlicensed uplink carrier (Block 515). In this case, the signaling may also indicate that the wireless device is allowed to instead perform the one or more uplink transmissions on the licensed uplink carrier if one or more conditions are fulfilled.

Alternatively or additionally, the method may include receiving, from the wireless device, a request to perform the one or more uplink transmissions on the licensed uplink carrier or the unlicensed uplink carrier (Block 518).

In still other embodiments, the method may alternatively or additionally include receiving, from the wireless device, a report that indicates the obtained measure and/or that indicates occurrence of an event based on the obtained measure (Block 505).

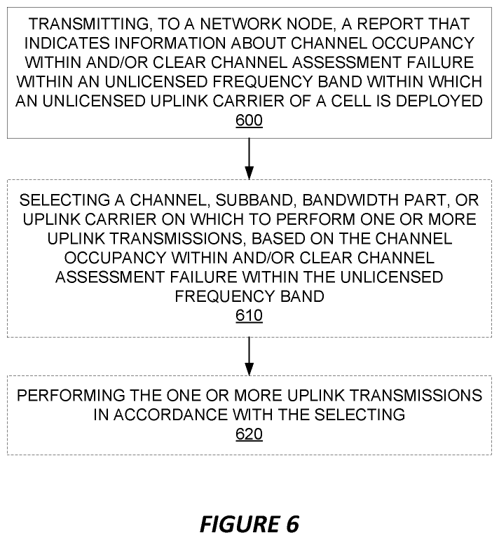

FIG. 6 depicts a method performed by a wireless device in accordance with other particular embodiments. The method includes transmitting, to a network node, a report that indicates information about channel occupancy within and/or clear channel assessment failure within an unlicensed frequency band within which an unlicensed uplink carrier of a cell is deployed (Block 600). In some embodiments, the method may also include selecting a channel, subband, bandwidth part, or uplink carrier on which to perform one or more uplink transmissions, based on the channel occupancy within and/or clear channel assessment failure within the unlicensed frequency band (Block 610). In this case, the method may further include performing the one or more uplink transmissions in accordance with the selecting (Block 620).

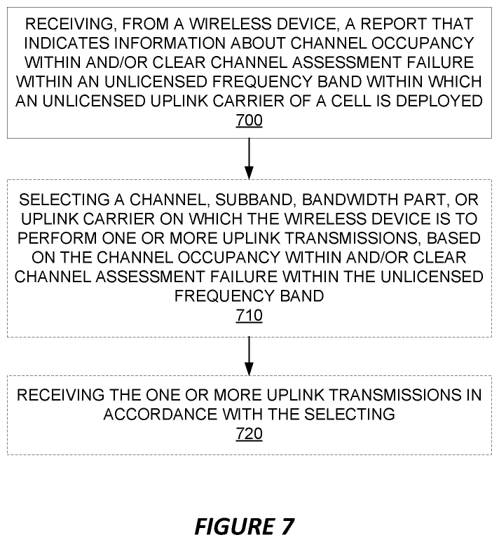

FIG. 7 depicts a method performed by a network node in accordance with other particular embodiments. The method includes receiving, from a wireless device, a report that indicates information about channel occupancy within and/or clear channel assessment failure within an unlicensed frequency band within which an unlicensed uplink carrier of a cell is deployed (Block 700). In some embodiments, the method may also include selecting a channel, subband, bandwidth part, or uplink carrier on which the wireless device is to perform one or more uplink transmissions, based on the channel occupancy within and/or clear channel assessment failure within the unlicensed frequency band (Block 710). In this case, the method may further include receiving the one or more uplink transmissions in accordance with the selecting (Block 720).

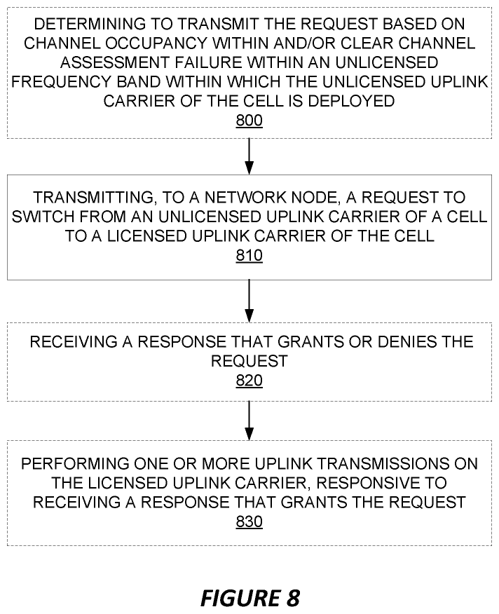

FIG. 8 depicts a method performed by a wireless device in accordance with other particular embodiments. The method includes transmitting, to a network node, a request to switch from an unlicensed uplink carrier of a cell to a licensed uplink carrier of the cell (Block 810). In some embodiments, the method may also include determining to transmit the request based on channel occupancy within and/or clear channel assessment failure within an unlicensed frequency band within which the unlicensed uplink carrier of the cell is deployed (Block 800).

In one or more embodiments, the method may further include receiving a response that grants or denies the request (Block 820). The method may also include performing one or more uplink transmissions on the licensed uplink carrier, e.g., responsive to receiving a response that grants the request (Block 830).

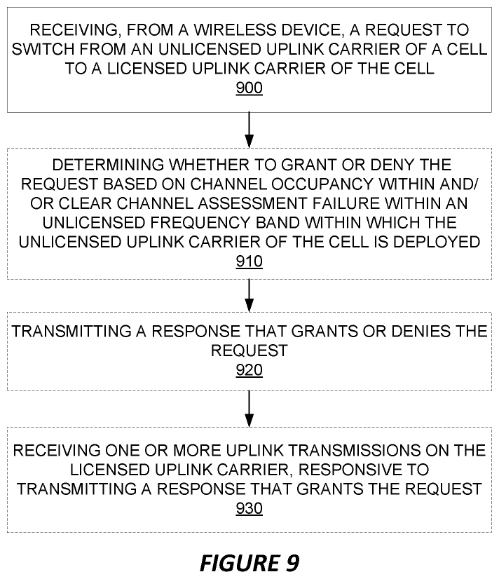

FIG. 9 depicts a method performed by a network node in accordance with other particular embodiments. The method includes receiving, from a wireless device, a request to switch from an unlicensed uplink carrier of a cell to a licensed uplink carrier of the cell (Block 900). The method in some embodiments also includes determining whether to grant or deny the request based on channel occupancy within and/or clear channel assessment failure within an unlicensed frequency band within which the unlicensed uplink carrier of the cell is deployed (Block 910). Alternatively or additionally, the method may include transmitting a response that grants or denies the request (Block 920). In some embodiments, the method further includes receiving one or more uplink transmissions on the licensed uplink carrier, e.g., responsive to transmitting a response that grants the request (Block 930).

Note further that while some embodiments have been exemplified with carrier selection, embodiments may be equally applicable to selection of a channel, subband, bandwidth part, or uplink carrier on which the wireless device 12 is to perform one or more uplink transmissions, based on the channel occupancy within and/or clear channel assessment failure within the unlicensed frequency band.

Note also that the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

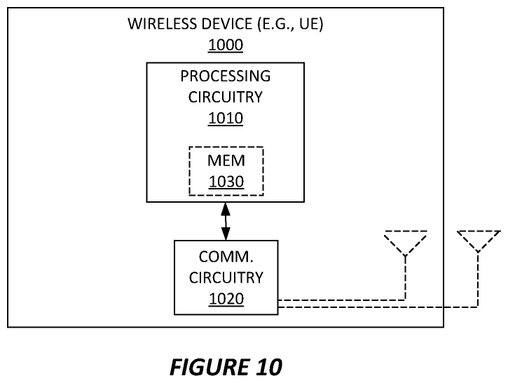

FIG. 10 for example illustrates a wireless device 1000 as implemented in accordance with one or more embodiments. As shown, the wireless device 1000 includes processing circuitry 1010 and communication circuitry 1020. The communication circuitry 1020 (e.g., radio circuitry) is configured to transmit and/or receive information to and/or from one or more other nodes, e.g., via any communication technology. Such communication may occur via one or more antennas that are either internal or external to the wireless device 1000. The processing circuitry 1010 is configured to perform processing described above, e.g., in FIGS. 4, 6, and/or 8, such as by executing instructions stored in memory 1030. The processing circuitry 1010 in this regard may implement certain functional means, units, or modules.

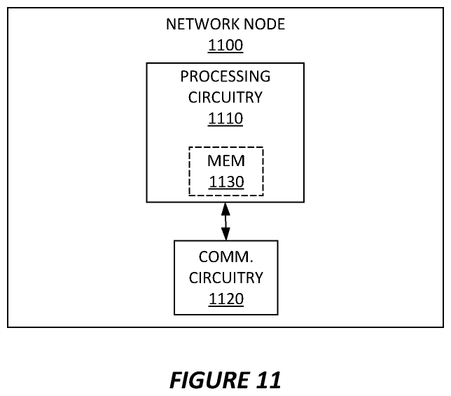

FIG. 11 illustrates a network node 1100 as implemented in accordance with one or more embodiments. As shown, the network node 1100 includes processing circuitry 1110 and communication circuitry 1120. The communication circuitry 1120 is configured to transmit and/or receive information to and/or from one or more other nodes, e.g., via any communication technology. The processing circuitry 1110 is configured to perform processing described above, e.g., in FIGS. 5, 7, and/or 9, such as by executing instructions stored in memory 1130. The processing circuitry 1110 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

As the low carrier frequency bands were already deployed with 2G, 3G and 4G wireless communication systems, New Radio (NR) will be deployed at relatively higher frequencies. For wireless communication, the propagation loss will be roughly proportional to the square of the carrier frequency. Hence there can be coverage issues for wireless communication over high carrier frequencies. For downlink (DL), the gNB can be equipped with powerful antenna systems and powerful amplifiers to boost the transmission power density; hence, the DL coverage can be boosted. However, for uplink (UL), there are several restrictions such as transmit power, antenna size and cost. Hence, there can be mismatch between UL and DL for a NR cell at high frequency.

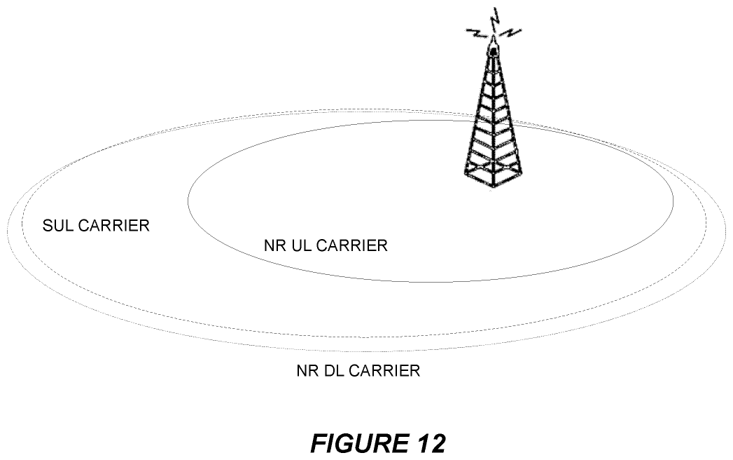

An NR cell therefore has a supplementary uplink (SUL) carrier, i.e. a NR cell has a SUL carrier plus a NR UL (NUL) carrier. The SUL carrier may be a low frequency carrier which can be shared (in time and/or frequency domain) with other radio access technology (RAT) system such as Long Term Evolution (LTE). FIG. 12 shows the coverages of the NR UL carrier and the SUL carrier in a NR cell, i.e., the NR frequency combination of a paired carrier and SUL (for UL only).

Since there are two uplink carriers for a NR cell in this case, the random access can be initiated in either NR UL carrier or SUL carrier. A user equipment (UE) can select which carrier for random access based on a channel quality threshold. If the UE determines it is close to the gNB based on the threshold, the UE shall select the NR UL carrier for random access due to the radio condition being good enough to finish the random access procedure over NR UL carrier. Otherwise, the UE shall select SUL carrier to finish the random access procedure. In this way, the random access load can be offloaded between two UL carriers in a NR cell.

### NR in Unlicensed Spectrum (NR-U)

Currently the 5th generation of cellular system, called New Radio (NR) is being standardized in 3GPP. NR is developed for maximum flexibility to support multiple and substantially different use cases. NR targets not only the typical mobile broadband use case, bur also machine type communication (MTC), ultra-low latency critical communications (ULLCC), side-link device-to-device (D2D) and several other use cases too.

In NR, the basic scheduling unit is called a slot. A slot consists of 14 Orthogonal Frequency Division Multiplexing (OFDM) symbols for the normal cyclic prefix configuration. NR supports many different subcarrier spacing configurations and at a subcarrier spacing of 30 kHz the OFDM symbol duration is ˜33 us. As an example, a slot with 14 symbols for the same subcarrier-spacing (SCS) is 500 us long (including cyclic prefixes).

NR also supports flexible bandwidth configurations for different UEs on the same serving cell. In other words, the bandwidth monitored by a UE and used for its control and data channels may be smaller than the carrier bandwidth. One or multiple bandwidth part configurations for each component carrier can be semi-statically signaled to a UE, where a bandwidth part consists of a group of contiguous Physical Resource Blocks (PRBs). Reserved resources can be configured within the bandwidth part. The bandwidth of a bandwidth part is equal to or is smaller than the maximal bandwidth capability supported by a UE.

NR is targeting both licensed and unlicensed bands. Allowing unlicensed networks, i.e., networks that operate in shared spectrum (or unlicensed spectrum), to effectively use the available spectrum is an attractive approach to increase system capacity. Although unlicensed spectrum does not match the qualities of the licensed regime, solutions that allow an efficient use of it as a complement to licensed deployments have the potential to bring great value to the 3GPP operators, and, ultimately, to the 3GPP industry as a whole. It is expected that some features in NR will need to be adapted to comply with the special characteristics of the unlicensed band as well as also different regulations. Subcarrier spacings of 15 or 30 kHz are the most promising candidates for NR-U Orthogonal Frequency Division Multiplexing (OFDM) numerologies for frequencies below 6 GHz.

When operating in unlicensed spectrum, many regions in the world require a device to sense the medium as free before transmitting, This operation is often referred to as listen before talk or LBT for short. There are many different flavors of LBT, depending on which radio technology the device uses and which type of data it wants to transmit at the moment. Common for all flavors is that the sensing is done in a particular channel (corresponding to a defined carrier frequency) and over a predefined bandwidth. For example, in the 5 GHz band, the sensing is done over 20 MHz channels.

Many devices are capable of transmitting (and receiving) over a wide bandwidth including multiple sub-bands/channels, e.g., LBT sub-bands (i.e., the frequency part with bandwidth equals to LBT bandwidth). A device is only allowed to transmit on the sub-bands where the medium is sensed as free. Again, there are different flavors of how the sensing should be done when multiple sub-bands are involved.

There are two ways a device can operate over multiple sub-bands. One way is that the transmitter/receiver bandwidth is changed depending on which sub-bands were sensed as free. In this setup, there is only one component carrier (CC) and the multiple sub-bands are treated as a single channel with a larger bandwidth. The other way is that the device operates almost independent processing chains for each channel. Depending on how independent the processing chains are, this option can be referred to as either carrier aggregation (CA) or dual connectivity (DC).

### Channel Access Procedure in NR Unlicensed Spectrum

Listen-before-talk (LBT) is designed for unlicensed spectrum co-existence with other radio access technologies (RATs). In this mechanism, a radio device applies a clear channel assessment (CCA) check (i.e. channel sensing) before any transmission. The transmitter involves energy detection (ED) over a time period compared to a certain threshold (ED threshold) in order to determine if a channel is idle. In case the channel is determined to be occupied, the transmitter performs a random back-off within a contention window before its next CCA attempt. In order to protect the ACK transmissions, the transmitter must defer a period after each busy CCA slot prior to resuming back-off. As soon as the transmitter has grasped access to a channel, the transmitter is only allowed to perform transmission up to a maximum time duration (namely, the maximum channel occupancy time (MCOT)). For quality of service (QoS) differentiation, a channel access priority based on the service type has been defined. For example, there are four LBT priority classes defined for differentiation of contention window sizes (CWS) and MCOT between services.

There currently exist certain challenge(s). In NR-U, it is feasible to deploy a SUL carrier to provide additional FDM resources for the UE so that it is beneficial to minimize the negative impact of LBT failures on UL transmissions. In this scenario then, an SUL carrier is deployed for a standalone NR-U cell. That is, a stand-alone NR cell is deployed in an unlicensed band and an UL carrier is deployed in a licensed band (single cell architecture).

The support of SUL carrier for NR-U should be designed on top of NR licensed SUL framework in Rel-15. In NR licensed, switching between the NUL carrier and the SUL carrier means that the UL transmissions move from one carrier to the other carrier, which is done by either: (i) an indication in downlink control information (DCI); or (ii) the Random Access (RA) procedure.

In addition, an RSRP threshold rsrp-ThresholdSSB-SUL may be used for the selection between the NUL carrier and the SUL carrier. In particular, as specified in the Medium Access Control (MAC) 3GPP specification, 38.321 v 15.4.0:
1> if the Serving Cell for the Random Access procedure is configured with supplementaryUplink; and
1> if the RSRP of the downlink pathloss reference is less than rsrp-ThresholdSSB-SUL:
   2> select the SUL carrier for performing Random Access procedure;
   2> set the PCMAX to PCMAX,f,c of the SUL carrier.
1> else:
   2> select the NUL carrier for performing Random Access procedure;
   2> set the PCMAX to P_{CMAX,f,c} of the NUL carrier.

As a summary, switching between the NUL carrier and the SUL carrier for UL transmissions can be either indicated by a DCI or a RA triggered in the UE. For RA, the UE selects the carrier based on an RSRP threshold rsrp-ThresholdSSB-SUL configured by the network.

However, it is expected that the above switch methods may be not sufficient for NR-U. Several issues are identified and highlighted below.

Issue 1: a carrier switch decision made by the gNB for a UE to order the UE to switch UL transmissions to the NUL carrier (i.e., unlicensed carrier) may be not suitable, since the gNB may not have timely knowledge of channel occupancy or LBT statistics of the NUL carrier of the UE. In one example, after receiving a switch decision to the NUL carrier, it may occur that subsequent UL transmissions on the NUL carrier may be blocked by the LBT failures. In this case, it would be better for the UE to perform UL transmissions on the SUL carrier instead of the NUL carrier. In another example, the gNB has ordered to the UE to move UL transmissions to the SUL carrier, while the NUL carrier may have low channel occupancy. In this case, it may be a better option for the UE to perform UL transmissions on the NUL carrier for higher UL data rate.

Issue 2: a UE selects a carrier for a RA purely based on measured DL reference signal received power (RSRP), not considering channel occupancy or LBT statistics of the NUL carrier. This may lead to a wrong switch decision to the NUL carrier for a RA, such that the RA may be blocked by LBT failures on the NUL carrier.

Given the above issues, it proves challenging for a UE to do a fast carrier switch while still allowing the gNB to make the final switch decision.

Certain aspects of the present disclosure and their embodiments may provide solutions to these or other challenges. Some embodiments propose how to enhance the existing carrier switch between a NUL carrier and an SUL carrier in an NR-U cell configured with an SUL carrier in licensed band. The UE in some embodiments indicates a carrier switch request (as an example of request 20 in FIG. 2) based on measured CO, or experienced LBT failures on the NUL carrier. The carrier switch request can be sent on the SUL carrier. The carrier switch request may also carry information such as failure reason, indicator on the carrier switch, detailed measurement results on CO or LBT failures, etc.

Certain embodiments may provide one or more of the following technical advantage(s): (i) Efficient carrier switch between unlicensed carrier and licensed carrier considering measured CO or LBT failures; (ii) Avoid UL transmissions on unlicensed carriers to be blocked by LBT failures; and/or (iii) Reliable mechanism to detect LBT failures and perform a fast carrier switch accordingly.

Consider now various embodiments which may be implemented separately or in combination.

In a first embodiment, for UL transmissions of a UE, a carrier selection (made by the UE or its serving gNB) is made considering not only channel quality (such as the DL measured RSRP) of both carriers, but also considering channel occupancy or LBT statistics (such as LBT failure occurrence) of the NUL carrier/the unlicensed carrier.

In a second embodiment, the UE may measure channel occupancy or LBT statistics periodically on the NUL carrier. The UE may also rely on or combine received measurement results of CO or LBT statistics on the NUL carrier from the gNB, which is signaled by the gNB via dedicated RRC signaling or system information, MAC CE or a DCI. The measurements may be performed per channel/subband/BWP on the NUL carrier. The measurements may be also performed per service/LCH/transmission type/channel access category and/or channel access priority class.

In a second embodiment, in order to select a carrier for a RA triggered by the UE, the UE performs the below actions
1> if the RSRP of the downlink pathloss reference is less than rsrp-ThresholdSSB-SUL or channel occupancy/LBT failure ratio/number of consecutively occurred LBT failures (e.g., within a configured time) is equal or more than co-Threshold-SUL/Ibtfailureratio-Threshold-SUL
   2> select the SUL carrier for performing Random Access procedure;
   2> set the PCMAX to PCMAX,f,c of the SUL carrier.
1> else:
   2> select the NUL carrier for performing Random Access procedure;
   2> set the PCMAX to PCMAX,f,c of the NUL carrier.

The new thresholds co-Threshold-SUL/Ibtfailureratio-Threshold-SUL may be signaled by the gNB via dedicated RRC signaling or system information, MAC Control Element (CE) or a Downlink Control Information (DCI). In one example, if CO or LBT failures/statistics is performed per channel/subband/BWP, the threshold co-Threshold-SUL/Ibtfailureratio-Threshold-SUL can be configured per channel/subband/BWP/service/CAPC (where CAPC stands for Channel Access Priority Class). In the above carrier selection procedure, the UE would then select the NUL carrier in case at least one channel/subband/BWP has measured CO or LBT failure ratio or the number of consecutively occurred LBT failures, which are lower than a configured threshold. In another example, if CO or LBT failures/statistics is performed per service or CAPC, the UE would then select the NUL carrier in case the measured CO or LBT failure ratio or the number of consecutively occurred LBT failures, are lower than a configured threshold for a specific service or CAPC.

In a fourth embodiment, an event is triggered when at least one condition is fulfilled. The condition(s) may include, for example:
1) the measured LBT failure ratio (e.g., within a configured time) of the NUL carrier is equal or more than a configured threshold;
2) A maximum number of consecutive LBT failures on the NUL carrier within a preconfigured interval is reached with respect to the transmission of one or multiple uplink physical channels, such as Physical Uplink Shared Channel (PUSCH), Physical Random Access Channel (PRACH), Physical Uplink Control Channel (PUCCH) or Sounding Reference Signal (SRS). In this case, the Physical (PHY) layer may need to send an indicator on the outcome of the LBT operation to the MAC layer.
3) A maximum time since a transmission (either UL transmission on the NUL carrier, or DL transmission) is triggered at the MAC until the transmission is started after success of LBT operation on the PHY layer, has elapsed.
4) Since the UE has detected a last DL control reference signal, the time period during which the UE has not detected any DL control signal has reached a preconfigured threshold. In this case, the UE could not receive the DL reference signals (such as Discovery Reference Signal, DRS, or Synchronization Signal and Physical Broadcast Channel Block, SSB/PBCH block, or Channel State Information Reference Signal, CSI-RS) since the gNB may experience LBT failures.
5) The measured channel occupancy has been equal or exceeded a preconfigured threshold.

For any of the above conditions, the measurements may be performed per channel/subband/BWP/carrier on the NUL carrier. The event means that the UE is experiencing a high congestion/collision in the current serving channel/subband/BWP/carrier.

When an event is triggered and reported to an upper layer (e.g. MAC or RRC), the upper layer may further inform the physical layer to measure channels/subbands/BWPs other than the ones that serve the UE, if they have not been measured. Once the measurement results are available, the physical layer reports the best candidate channels/BWP/carrier/cell to upper layers.

Upon triggering of the event, the UE may take different actions depending on whether the event triggered on the NUL carrier is per channel/subband, or per BWP, or per carrier. In case the event is triggered per channel/subband, the UE may choose to use other channels/subbands for UL transmissions on the NUL carrier. In case the event is triggered per BWP which may comprise a single channel/subband, or multiple subbands/channels, meaning that there is no any channel/subband with CO or LBT failure occurrence, lower than the preconfigured threshold, the UE may choose to switch to other BWPs on the NUL carrier for UL transmissions. In case the event is triggered per NUL carrier, which means that there is no any BWP with with lower CO or LBT failure occurrence lower than the preconfigured threshold, the UE may choose to switch to the SUL carrier for UL transmissions.

The UE may further report the failure event of the NUL carrier to the gNB comprising failure reasons and detailed measurements on CO or LBT statistics. The report may be sent on the SUL carrier via any of below signaling means indicating that the UE would like to move UL transmissions from the NUL carrier to the SUL carrier:
1) Sounding Reference Signal (SRS) transmission on the SUL carrier, i.e., SRS transmission on the SUL carrier. Separated SRS resources and time occasions may be configured by the gNB for such purpose accordingly.
2) Physical Uplink Control Channel (PUCCH) transmission on the SUL carrier, e.g., PUCCH-SR transmission on the SUL carrier.
3) RA transmission on the SUL carrier, e.g., a RA on the SUL carrier can indicate that the UE would like to move UL transmissions from the NUL carrier to the SUL carrier. Separated RA resources or RA time occasions may be configured by the gNB for such purpose accordingly.
4) A MAC control element (CE) or a Radio Resource Control (RRC) signaling message on the Physical Uplink Shared Channel (PUSCH) on the SUL carrier. The UE can provide detailed failure report on PUSCH on the SUL carrier. The failure report may carry information including failure reason, indicator on the carrier switch to the SUL carrier, detailed measurement results on CO/LBT statistics etc.

For any of the above signaling means, the gNB may need to configure SRS/PUCCH/RA/PUSCH resources on both carriers. In NR Rel-15, at least for PUCCH resources and Type 1 configured grant resources, a UE cannot be set with resources/configurations on both carriers. For NR-U cell with a licensed SUL carrier, such restriction must be removed.

In a fifth embodiment, in case a UE does a handover to an NR-U cell with an SUL carrier on licensed band, the handover command/reconfiguration with sync may carry at least one configured threshold for measured CO, or LBT failure ratio, or number of consecutively occurred LBT failures, which serves the purpose for the UE to select the carrier for UL transmission in the target cell. The UE may select the NUL carrier when the measured CO, LBT failure ratio or the number of consecutively experienced LBT failures is less than the configured threshold; otherwise, the UE would select the SUL carrier.

In a sixth embodiment, the UE has received a command (such as a DCI, a RRC, or a MAC CE) for UL transmission on the NUL carrier. The command has also carried other configuration information/condition indicating that the UE can switch to the SUL carrier if the condition is fulfilled, such as measured CO is above a configured threshold, or LBT failure occurrence is above a configured threshold. In addition, the command may also carry resource assignments on the SUL carrier. The UE can use these assigned resources for UL transmission if the UE switches to the SUL carrier.

Some embodiments herein are described in the context of NR unlicensed spectrum (NR-U). In these embodiments, an NR cell may be deployed in unlicensed band but supplemented by a SUL carrier in the licensed band. In other words, it is an NR cell in unlicensed band configured with an SUL carrier which is on licensed band. So, the NUL carrier is on unlicensed band. But embodiments herein are not limited to NR-U scenarios. They are also applicable to other unlicensed operation scenarios such as LTE LAA/eLAA/feLAA.

Consider now embodiments concerning additional transmission opportunities for NR-U with SUL in a licensed band.

In NR-U, it has been identified to be beneficial to provide more transmission opportunities for a UE to mitigate the negative impact imposed by LBT failures. The following scenarios are possible in NR-U:
Scenario A: Carrier aggregation between licensed band NR (PCell) and NR-U (SCell). The NR-U SCell may have both DL and UL, or DL-only. In this scenario, NR PCell is connected to 5G-CN.
Scenario B: Dual connectivity between licensed band LTE (PCell) and NR-U (PSCell). In this scenario, LTE PCell connected to the Evolved Packet Core (EPC) as higher priority than PCell connected to 5G-CN.
Scenario C: Stand-alone NR-U. In this scenario, NR-U is connected to 5G-CN.
Scenario D: A stand-alone NR cell in unlicensed band and UL in licensed band (single cell architecture). In this scenario, NR-U is connected to 5G-CN.
Scenario E: Dual connectivity between licensed band NR and NR-U. In this scenario, PCell is connected to 5G-CN.

### RP-182878, New WID on NR-based Access to Unlicensed Spectrum, Qualcomm Inc.

In NR-U, as defined in Scenario D, it is feasible to deploy the SUL carrier to provide additional frequency division multiplexing (FDM) resources for the UE so that it is beneficial to minimize the negative impact of LBT failures on UL transmissions.

Below are discussed aspects on how to deploy the SUL carrier in an NR-U cell accordingly.

Consider SUL in NR licensed. As the low carrier frequency bands were already deployed with 2G, 3G and 4G wireless communication systems, NR will be deployed at relatively higher frequencies. For wireless communication, the propagation loss will be roughly proportional to the square of the carrier frequency. Hence there can be coverage issue for wireless communication over high carrier frequencies. For downlink, the gNB can be equipped with powerful antenna systems and powerful amplifiers to boost the transmission power density, hence the DL coverage can be boosted. However, for UL, there are several restrictions such as transmit power, antenna size and cost. Hence there can be mismatch between UL and DL for a NR cell at high frequency.

For solving this, NR introduced a supplementary uplink (SUL) carrier for a NR cell, i.e. a NR cell has a SUL carrier plus a NR UL carrier. The SUL carrier is supposed to be a low frequency carrier which can be shared (in time and/or frequency domain) with other RAT system such as LTE.

FIG. 12 shows the coverages of the NR UL carrier and the SUL carrier in a NR cell, i.e., an NR frequency combination of paired carrier and SUL (for UL only). Since there are two uplink carriers for a NR cell in this case, the random access can be initiated in either NR UL carrier or SUL carrier. A UE can heretofore select which carrier for random access based on a threshold. If the UE determine it is close to the gNB based on the threshold, a UE heretofore shall select the NR UL carrier for random access due to the radio condition being good enough to finish the random access procedure over NR UL carrier. Otherwise, the UE shall heretofore select SUL carrier to finish the random access procedure. In such way, the random access load can be offloaded between two UL carriers in a NR cell.

In NR-U, as defined in Scenario D, it is feasible to deploy SUL carrier to provide additional FDM resources for the UE so that it is beneficial to minimize the negative impact of LBT failures on UL transmissions.

Consider now SUL in NR-U. The support of SUL carrier for NR-U should be designed on top of NR licensed SUL framework in Rel-15. In NR licensed, switching between the NUL carrier and the SUL carrier means that the UL transmissions move from one carrier to the other carrier, which is done by:
an indication in DCI;
the Random Access procedure.
   For the former option, a carrier switch decision made by the gNB for a UE to switch UL transmissions to the NUL carrier (i.e., unlicensed carrier) may be not suitable, since the gNB may not have timely knowledge of channel occupancy or LBT statistics of the NUL carrier of the UE. In one example, after receiving a switch decision to the NUL carrier, it may occur that subsequent UL transmissions on the NUL carrier may be blocked by the LBT failures. It would be better for the UE to perform UL transmissions on the SUL carrier instead of the NUL carrier.

Regarding UL LBT failure handling, a mechanism in MAC 3GPP specifications should handle the UL LBT failure, where “consistent” UL LBT failures (at least for UL transmissions of a scheduling request, SR, random access channel, RACH, physical uplink shared channel, PUSCH) are used for problem detection. This mechanism may be applied for assisting carrier switch in this case. A UE can measure LBT failures periodically on the NUL carrier. The UE may also rely on or combine received measurement results of channel occupancy (CO) or LBT failures on the NUL carrier from the gNB, which is signaled by the gNB. The measurements may be performed per subband and per BWP, if the NUL carrier is configured with a wideband BWP, which comprises multiple LBT subbands. When a UE has experienced consistent UL LBT failures, an event is triggered. The UE may take different actions depending on whether the event triggered on the NUL carrier is per subband, or per BWP, or per carrier. The UE may choose to use other subbands for UL transmissions on the NUL carrier if there are consistent UL LBT failures on one serving subband. Or, the UE may switch to other BWP, if there are consistent UL LBT failures in its active BWP, meaning that all subbands are congested. Or, the UE may choose to switch to the SUL carrier for UL transmissions if there are consistent UL LBT failures in its active BWP, and there is no other BWPs configured for the UE in the cell.

The UE may further report the failure reason to the gNB. The failure report can be sent via the SUL carrier. Therefore, according to some embodiments, in an NR-U cell configured with SUL carrier in a licensed band, the UE monitors “consistent” UL LBT failures (at least for UL transmissions of SR, RACH, PUSCH) on the NUL carrier. In some embodiments, a UE can declare a UL LBT problem upon detection of “consistent” UL LBT failures on the NUL carrier. In some embodiments, in an NR-U cell configured with SUL carrier in licensed band, the UE reports the failure reason to the gNB via the SUL carrier. In some embodiments, in an NR-U cell configured with SUL carrier in a licensed band, the UE switches to the SUL carrier for UL transmissions upon detection of “consistent” UL LBT on the NUL carrier. If the UE can declare a LBT problem concerning “consistent DL LBT failures”, the similar conclusion is also applicable to Scenario D.

In addition, an RSRP threshold rsrp-ThresholdSSB-SUL for the selection between the NUL carrier and the SUL carrier may be employed as specified in the Medium Access Control (MAC) 3GPP specification TS 38.321:
1> if the Serving Cell for the Random Access procedure is configured with supplementaryUplink; and
1> if the RSRP of the downlink pathloss reference is less than rsrp-ThresholdSSB-SUL:
   2> select the SUL carrier for performing Random Access procedure;
   2> set the PCMAX to P_{CMAX,f,c} of the SUL carrier.
1> else:
   2> select the NUL carrier for performing Random Access procedure;
   2> set the PCMAX to P_{CMAX,f,c} of the NUL carrier.
      A UE heretofore selects a carrier for a random access (RA) purely based on measured DL RSRP, not considering channel occupancy or LBT failure statistics of the NUL carrier. This may lead to a wrong switch decision to the NUL carrier for a RA, such that the RA may be blocked by LBT failures on the NUL carrier. Accordingly, purely based on the measured DL RSRP, the UE may select a carrier which is not suitable for a RA.

It is beneficial for the UE to select a carrier for RA considering measured LBT failure statistics or CO on the NUL carrier. For the initial system access, the UE may not be able to measure CO or monitor LBT failures on the NUL carrier. In this case, the gNB may provide measurement results to the UE. Therefore, according to some embodiments, in an NR-U cell configured with SUL carrier in licensed band, the UE selects a carrier (either the SUL or the NUL) for a RA considering measured LBT failures or CO on the NUL carrier.

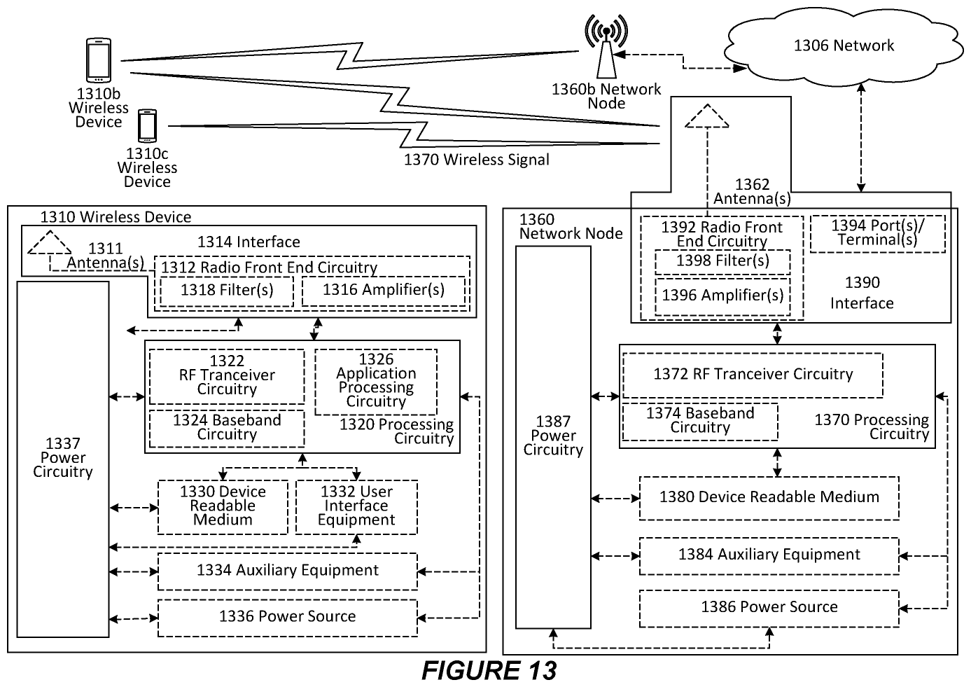

Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 1306, network nodes 1360 and 1360b, and WDs 1310, 1310b, and 1310c. In practice, a wireless network may further include any additional elements suitable to support communication between wireless devices or between a wireless device and another communication device, such as a landline telephone, a service provider, or any other network node or end device. Of the illustrated components, network node 1360 and wireless device (WD) 1310 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1306 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1360 and WD 1310 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 13, network node 1360 includes processing circuitry 1370, device readable medium 1380, interface 1390, auxiliary equipment 1384, power source 1386, power circuitry 1387, and antenna 1362. Although network node 1360 illustrated in the example wireless network of FIG. 13 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1360 are depicted as single boxes located within a larger box, or nested within multiple boxes, in practice, a network node may comprise multiple different physical components that make up a single illustrated component (e.g., device readable medium 1380 may comprise multiple separate hard drives as well as multiple RAM modules).

Similarly, network node 1360 may be composed of multiple physically separate components (e.g., a NodeB component and a RNC component, or a BTS component and a BSC component, etc.), which may each have their own respective components. In certain scenarios in which network node 1360 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1360 may be configured to support multiple radio access technologies (RATs). In such embodiments, some components may be duplicated (e.g., separate device readable medium 1380 for the different RATs) and some components may be reused (e.g., the same antenna 1362 may be shared by the RATs). Network node 1360 may also include multiple sets of the various illustrated components for different wireless technologies integrated into network node 1360, such as, for example, GSM, WCDMA, LTE, NR, WiFi, or Bluetooth wireless technologies. These wireless technologies may be integrated into the same or different chip or set of chips and other components within network node 1360.

Processing circuitry 1370 is configured to perform any determining, calculating, or similar operations (e.g., certain obtaining operations) described herein as being provided by a network node. These operations performed by processing circuitry 1370 may include processing information obtained by processing circuitry 1370 by, for example, converting the obtained information into other information, comparing the obtained information or converted information to information stored in the network node, and/or performing one or more operations based on the obtained information or converted information, and as a result of said processing making a determination.

Processing circuitry 1370 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1360 components, such as device readable medium 1380, network node 1360 functionality. For example, processing circuitry 1370 may execute instructions stored in device readable medium 1380 or in memory within processing circuitry 1370. Such functionality may include providing any of the various wireless features, functions, or benefits discussed herein. In some embodiments, processing circuitry 1370 may include a system on a chip (SOC).

In some embodiments, processing circuitry 1370 may include one or more of radio frequency (RF) transceiver circuitry 1372 and baseband processing circuitry 1374. In some embodiments, radio frequency (RF) transceiver circuitry 1372 and baseband processing circuitry 1374 may be on separate chips (or sets of chips), boards, or units, such as radio units and digital units. In alternative embodiments, part or all of RF transceiver circuitry 1372 and baseband processing circuitry 1374 may be on the same chip or set of chips, boards, or units

In certain embodiments, some or all of the functionality described herein as being provided by a network node, base station, eNB or other such network device may be performed by processing circuitry 1370 executing instructions stored on device readable medium 1380 or memory within processing circuitry 1370. In alternative embodiments, some or all of the functionality may be provided by processing circuitry 1370 without executing instructions stored on a separate or discrete device readable medium, such as in a hard-wired manner. In any of those embodiments, whether executing instructions stored on a device readable storage medium or not, processing circuitry 1370 can be configured to perform the described functionality. The benefits provided by such functionality are not limited to processing circuitry 1370 alone or to other components of network node 1360, but are enjoyed by network node 1360 as a whole, and/or by end users and the wireless network generally.

Device readable medium 1380 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1370. Device readable medium 1380 may store any suitable instructions, data or information, including a computer program, software, an application including one or more of logic, rules, code, tables, etc. and/or other instructions capable of being executed by processing circuitry 1370 and, utilized by network node 1360. Device readable medium 1380 may be used to store any calculations made by processing circuitry 1370 and/or any data received via interface 1390. In some embodiments, processing circuitry 1370 and device readable medium 1380 may be considered to be integrated.

Interface 1390 is used in the wired or wireless communication of signalling and/or data between network node 1360, network 1306, and/or WDs 1310. As illustrated, interface 1390 comprises port(s)/terminal(s) 1394 to send and receive data, for example to and from network 1306 over a wired connection. Interface 1390 also includes radio front end circuitry 1392 that may be coupled to, or in certain embodiments a part of, antenna 1362. Radio front end circuitry 1392 comprises filters 1398 and amplifiers 1396. Radio front end circuitry 1392 may be connected to antenna 1362 and processing circuitry 1370. Radio front end circuitry may be configured to condition signals communicated between antenna 1362 and processing circuitry 1370. Radio front end circuitry 1392 may receive digital data that is to be sent out to other network nodes or WDs via a wireless connection. Radio front end circuitry 1392 may convert the digital data into a radio signal having the appropriate channel and bandwidth parameters using a combination of filters 1398 and/or amplifiers 1396. The radio signal may then be transmitted via antenna 1362. Similarly, when receiving data, antenna 1362 may collect radio signals which are then converted into digital data by radio front end circuitry 1392. The digital data may be passed to processing circuitry 1370. In other embodiments, the interface may comprise different components and/or different combinations of components.

In certain alternative embodiments, network node 1360 may not include separate radio front end circuitry 1392, instead, processing circuitry 1370 may comprise radio front end circuitry and may be connected to antenna 1362 without separate radio front end circuitry 1392. Similarly, in some embodiments, all or some of RF transceiver circuitry 1372 may be considered a part of interface 1390. In still other embodiments, interface 1390 may include one or more ports or terminals 1394, radio front end circuitry 1392, and RF transceiver circuitry 1372, as part of a radio unit (not shown), and interface 1390 may communicate with baseband processing circuitry 1374, which is part of a digital unit (not shown).

Antenna 1362 may include one or more antennas, or antenna arrays, configured to send and/or receive wireless signals. Antenna 1362 may be coupled to radio front end circuitry 1390 and may be any type of antenna capable of transmitting and receiving data and/or signals wirelessly. In some embodiments, antenna 1362 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1362 may be separate from network node 1360 and may be connectable to network node 1360 through an interface or port.

Antenna 1362, interface 1390, and/or processing circuitry 1370 may be configured to perform any receiving operations and/or certain obtaining operations described herein as being performed by a network node. Any information, data and/or signals may be received from a wireless device, another network node and/or any other network equipment. Similarly, antenna 1362, interface 1390, and/or processing circuitry 1370 may be configured to perform any transmitting operations described herein as being performed by a network node. Any information, data and/or signals may be transmitted to a wireless device, another network node and/or any other network equipment.

Power circuitry 1387 may comprise, or be coupled to, power management circuitry and is configured to supply the components of network node 1360 with power for performing the functionality described herein. Power circuitry 1387 may receive power from power source 1386. Power source 1386 and/or power circuitry 1387 may be configured to provide power to the various components of network node 1360 in a form suitable for the respective components (e.g., at a voltage and current level needed for each respective component). Power source 1386 may either be included in, or external to, power circuitry 1387 and/or network node 1360. For example, network node 1360 may be connectable to an external power source (e.g., an electricity outlet) via an input circuitry or interface such as an electrical cable, whereby the external power source supplies power to power circuitry 1387. As a further example, power source 1386 may comprise a source of power in the form of a battery or battery pack which is connected to, or integrated in, power circuitry 1387. The battery may provide backup power should the external power source fail. Other types of power sources, such as photovoltaic devices, may also be used.

Alternative embodiments of network node 1360 may include additional components beyond those shown in FIG. 13 that may be responsible for providing certain aspects of the network node's functionality, including any of the functionality described herein and/or any functionality necessary to support the subject matter described herein. For example, network node 1360 may include user interface equipment to allow input of information into network node 1360 and to allow output of information from network node 1360. This may allow a user to perform diagnostic, maintenance, repair, and other administrative functions for network node 1360.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1310 includes antenna 1311, interface 1314, processing circuitry 1320, device readable medium 1330, user interface equipment 1332, auxiliary equipment 1334, power source 1336 and power circuitry 1337. WD 1310 may include multiple sets of one or more of the illustrated components for different wireless technologies supported by WD 1310, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1310.

Antenna 1311 may include one or more antennas or antenna arrays, configured to send and/or receive wireless signals, and is connected to interface 1314. In certain alternative embodiments, antenna 1311 may be separate from WD 1310 and be connectable to WD 1310 through an interface or port. Antenna 1311, interface 1314, and/or processing circuitry 1320 may be configured to perform any receiving or transmitting operations described herein as being performed by a WD. Any information, data and/or signals may be received from a network node and/or another WD. In some embodiments, radio front end circuitry and/or antenna 1311 may be considered an interface.

As illustrated, interface 1314 comprises radio front end circuitry 1312 and antenna 1311. Radio front end circuitry 1312 comprise one or more filters 1318 and amplifiers 1316. Radio front end circuitry 1314 is connected to antenna 1311 and processing circuitry 1320, and is configured to condition signals communicated between antenna 1311 and processing circuitry 1320. Radio front end circuitry 1312 may be coupled to or a part of antenna 1311. In some embodiments, WD 1310 may not include separate radio front end circuitry 1312; rather, processing circuitry 1320 may comprise radio front end circuitry and may be connected to antenna 1311. Similarly, in some embodiments, some or all of RF transceiver circuitry 1322 may be considered a part of interface 1314. Radio front end circuitry 1312 may receive digital data that is to be sent out to other network nodes or WDs via a wireless connection. Radio front end circuitry 1312 may convert the digital data into a radio signal having the appropriate channel and bandwidth parameters using a combination of filters 1318 and/or amplifiers 1316. The radio signal may then be transmitted via antenna 1311. Similarly, when receiving data, antenna 1311 may collect radio signals which are then converted into digital data by radio front end circuitry 1312. The digital data may be passed to processing circuitry 1320. In other embodiments, the interface may comprise different components and/or different combinations of components.

Processing circuitry 1320 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1310 components, such as device readable medium 1330, WD 1310 functionality. Such functionality may include providing any of the various wireless features or benefits discussed herein. For example, processing circuitry 1320 may execute instructions stored in device readable medium 1330 or in memory within processing circuitry 1320 to provide the functionality disclosed herein.

As illustrated, processing circuitry 1320 includes one or more of RF transceiver circuitry 1322, baseband processing circuitry 1324, and application processing circuitry 1326. In other embodiments, the processing circuitry may comprise different components and/or different combinations of components. In certain embodiments processing circuitry 1320 of WD 1310 may comprise a SOC. In some embodiments, RF transceiver circuitry 1322, baseband processing circuitry 1324, and application processing circuitry 1326 may be on separate chips or sets of chips. In alternative embodiments, part or all of baseband processing circuitry 1324 and application processing circuitry 1326 may be combined into one chip or set of chips, and RF transceiver circuitry 1322 may be on a separate chip or set of chips. In still alternative embodiments, part or all of RF transceiver circuitry 1322 and baseband processing circuitry 1324 may be on the same chip or set of chips, and application processing circuitry 1326 may be on a separate chip or set of chips. In yet other alternative embodiments, part or all of RF transceiver circuitry 1322, baseband processing circuitry 1324, and application processing circuitry 1326 may be combined in the same chip or set of chips. In some embodiments, RF transceiver circuitry 1322 may be a part of interface 1314. RF transceiver circuitry 1322 may condition RF signals for processing circuitry 1320.

In certain embodiments, some or all of the functionality described herein as being performed by a WD may be provided by processing circuitry 1320 executing instructions stored on device readable medium 1330, which in certain embodiments may be a computer-readable storage medium. In alternative embodiments, some or all of the functionality may be provided by processing circuitry 1320 without executing instructions stored on a separate or discrete device readable storage medium, such as in a hard-wired manner. In any of those particular embodiments, whether executing instructions stored on a device readable storage medium or not, processing circuitry 1320 can be configured to perform the described functionality. The benefits provided by such functionality are not limited to processing circuitry 1320 alone or to other components of WD 1310, but are enjoyed by WD 1310 as a whole, and/or by end users and the wireless network generally.

Processing circuitry 1320 may be configured to perform any determining, calculating, or similar operations (e.g., certain obtaining operations) described herein as being performed by a WD. These operations, as performed by processing circuitry 1320, may include processing information obtained by processing circuitry 1320 by, for example, converting the obtained information into other information, comparing the obtained information or converted information to information stored by WD 1310, and/or performing one or more operations based on the obtained information or converted information, and as a result of said processing making a determination.

Device readable medium 1330 may be operable to store a computer program, software, an application including one or more of logic, rules, code, tables, etc. and/or other instructions capable of being executed by processing circuitry 1320. Device readable medium 1330 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1320. In some embodiments, processing circuitry 1320 and device readable medium 1330 may be considered to be integrated.

User interface equipment 1332 may provide components that allow for a human user to interact with WD 1310. Such interaction may be of many forms, such as visual, audial, tactile, etc. User interface equipment 1332 may be operable to produce output to the user and to allow the user to provide input to WD 1310. The type of interaction may vary depending on the type of user interface equipment 1332 installed in WD 1310. For example, if WD 1310 is a smart phone, the interaction may be via a touch screen; if WD 1310 is a smart meter, the interaction may be through a screen that provides usage (e.g., the number of gallons used) or a speaker that provides an audible alert (e.g., if smoke is detected). User interface equipment 1332 may include input interfaces, devices and circuits, and output interfaces, devices and circuits. User interface equipment 1332 is configured to allow input of information into WD 1310, and is connected to processing circuitry 1320 to allow processing circuitry 1320 to process the input information. User interface equipment 1332 may include, for example, a microphone, a proximity or other sensor, keys/buttons, a touch display, one or more cameras, a USB port, or other input circuitry. User interface equipment 1332 is also configured to allow output of information from WD 1310, and to allow processing circuitry 1320 to output information from WD 1310. User interface equipment 1332 may include, for example, a speaker, a display, vibrating circuitry, a USB port, a headphone interface, or other output circuitry. Using one or more input and output interfaces, devices, and circuits, of user interface equipment 1332, WD 1310 may communicate with end users and/or the wireless network, and allow them to benefit from the functionality described herein.

Auxiliary equipment 1334 is operable to provide more specific functionality which may not be generally performed by WDs. This may comprise specialized sensors for doing measurements for various purposes, interfaces for additional types of communication such as wired communications etc. The inclusion and type of components of auxiliary equipment 1334 may vary depending on the embodiment and/or scenario.

Power source 1336 may, in some embodiments, be in the form of a battery or battery pack. Other types of power sources, such as an external power source (e.g., an electricity outlet), photovoltaic devices or power cells, may also be used. WD 1310 may further comprise power circuitry 1337 for delivering power from power source 1336 to the various parts of WD 1310 which need power from power source 1336 to carry out any functionality described or indicated herein. Power circuitry 1337 may in certain embodiments comprise power management circuitry. Power circuitry 1337 may additionally or alternatively be operable to receive power from an external power source; in which case WD 1310 may be connectable to the external power source (such as an electricity outlet) via input circuitry or an interface such as an electrical power cable. Power circuitry 1337 may also in certain embodiments be operable to deliver power from an external power source to power source 1336. This may be, for example, for the charging of power source 1336. Power circuitry 1337 may perform any formatting, converting, or other modification to the power from power source 1336 to make the power suitable for the respective components of WD 1310 to which power is supplied.

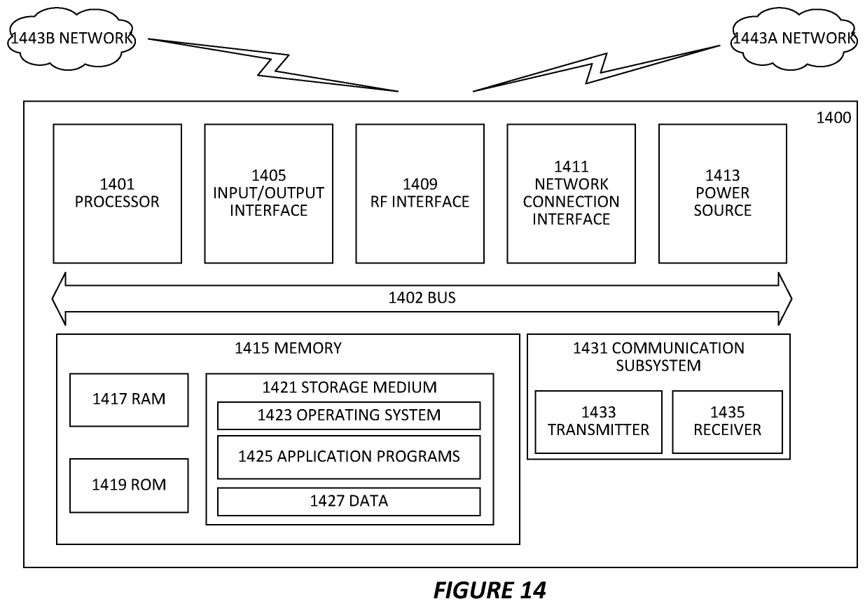

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 14200 may be any UE identified by the 3^{rd} Generation Partnership Project (3GPP), including a NB-IoT UE, a machine type communication (MTC) UE, and/or an enhanced MTC (eMTC) UE. UE 1400, as illustrated in FIG. 14, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 1400 includes processing circuitry 1401 that is operatively coupled to input/output interface 1405, radio frequency (RF) interface 1409, network connection interface 1411, memory 1415 including random access memory (RAM) 1417, read-only memory (ROM) 1419, and storage medium 1421 or the like, communication subsystem 1431, power source 1433, and/or any other component, or any combination thereof. Storage medium 1421 includes operating system 1423, application program 1425, and data 1427. In other embodiments, storage medium 1421 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 1401 may be configured to process computer instructions and data. Processing circuitry 1401 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1401 may include two central processing units (CPUs). Data may be information in a form suitable for use by a computer.

In the depicted embodiment, input/output interface 1405 may be configured to provide a communication interface to an input device, output device, or input and output device. UE 1400 may be configured to use an output device via input/output interface 1405. An output device may use the same type of interface port as an input device. For example, a USB port may be used to provide input to and output from UE 1400. The output device may be a speaker, a sound card, a video card, a display, a monitor, a printer, an actuator, an emitter, a smartcard, another output device, or any combination thereof. UE 1400 may be configured to use an input device via input/output interface 1405 to allow a user to capture information into UE 1400. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 1409 may be configured to provide a communication interface to RF components such as a transmitter, a receiver, and an antenna. Network connection interface 1411 may be configured to provide a communication interface to network 1443a. Network 1443a may encompass wired and/or wireless networks such as a local-area network (LAN), a wide-area network (WAN), a computer network, a wireless network, a telecommunications network, another like network or any combination thereof. For example, network 1443a may comprise a Wi-Fi network. Network connection interface 1411 may be configured to include a receiver and a transmitter interface used to communicate with one or more other devices over a communication network according to one or more communication protocols, such as Ethernet, TCP/IP, SONET, ATM, or the like. Network connection interface 1411 may implement receiver and transmitter functionality appropriate to the communication network links (e.g., optical, electrical, and the like). The transmitter and receiver functions may share circuit components, software or firmware, or alternatively may be implemented separately.

RAM 1417 may be configured to interface via bus 1402 to processing circuitry 1401 to provide storage or caching of data or computer instructions during the execution of software programs such as the operating system, application programs, and device drivers. ROM 1419 may be configured to provide computer instructions or data to processing circuitry 1401. For example, ROM 1419 may be configured to store invariant low-level system code or data for basic system functions such as basic input and output (I/O), startup, or reception of keystrokes from a keyboard that are stored in a non-volatile memory. Storage medium 1421 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1421 may be configured to include operating system 1423, application program 1425 such as a web browser application, a widget or gadget engine or another application, and data file 1427. Storage medium 1421 may store, for use by UE 1400, any of a variety of various operating systems or combinations of operating systems.

Storage medium 1421 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1421 may allow UE 1400 to access computer-executable instructions, application programs or the like, stored on transitory or non-transitory memory media, to off-load data, or to upload data. An article of manufacture, such as one utilizing a communication system may be tangibly embodied in storage medium 1421, which may comprise a device readable medium.

In FIG. 14, processing circuitry 1401 may be configured to communicate with network 1443b using communication subsystem 1431. Network 1443a and network 1443b may be the same network or networks or different network or networks. Communication subsystem 1431 may be configured to include one or more transceivers used to communicate with network 1443b. For example, communication subsystem 1431 may be configured to include one or more transceivers used to communicate with one or more remote transceivers of another device capable of wireless communication such as another WD, UE, or base station of a radio access network (RAN) according to one or more communication protocols, such as IEEE 802.14, CDMA, WCDMA, GSM, LTE, UTRAN, WiMax, or the like. Each transceiver may include transmitter 1433 and/or receiver 1435 to implement transmitter or receiver functionality, respectively, appropriate to the RAN links (e.g., frequency allocations and the like). Further, transmitter 1433 and receiver 1435 of each transceiver may share circuit components, software or firmware, or alternatively may be implemented separately.

In the illustrated embodiment, the communication functions of communication subsystem 1431 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1431 may include cellular communication, Wi-Fi communication, Bluetooth communication, and GPS communication. Network 1443b may encompass wired and/or wireless networks such as a local-area network (LAN), a wide-area network (WAN), a computer network, a wireless network, a telecommunications network, another like network or any combination thereof. For example, network 1443b may be a cellular network, a Wi-Fi network, and/or a near-field network. Power source 1413 may be configured to provide alternating current (AC) or direct current (DC) power to components of UE 1400.

The features, benefits and/or functions described herein may be implemented in one of the components of UE 1400 or partitioned across multiple components of UE 1400. Further, the features, benefits, and/or functions described herein may be implemented in any combination of hardware, software or firmware. In one example, communication subsystem 1431 may be configured to include any of the components described herein. Further, processing circuitry 1401 may be configured to communicate with any of such components over bus 1402. In another example, any of such components may be represented by program instructions stored in memory that when executed by processing circuitry 1401 perform the corresponding functions described herein. In another example, the functionality of any of such components may be partitioned between processing circuitry 1401 and communication subsystem 1431. In another example, the non-computationally intensive functions of any of such components may be implemented in software or firmware and the computationally intensive functions may be implemented in hardware.

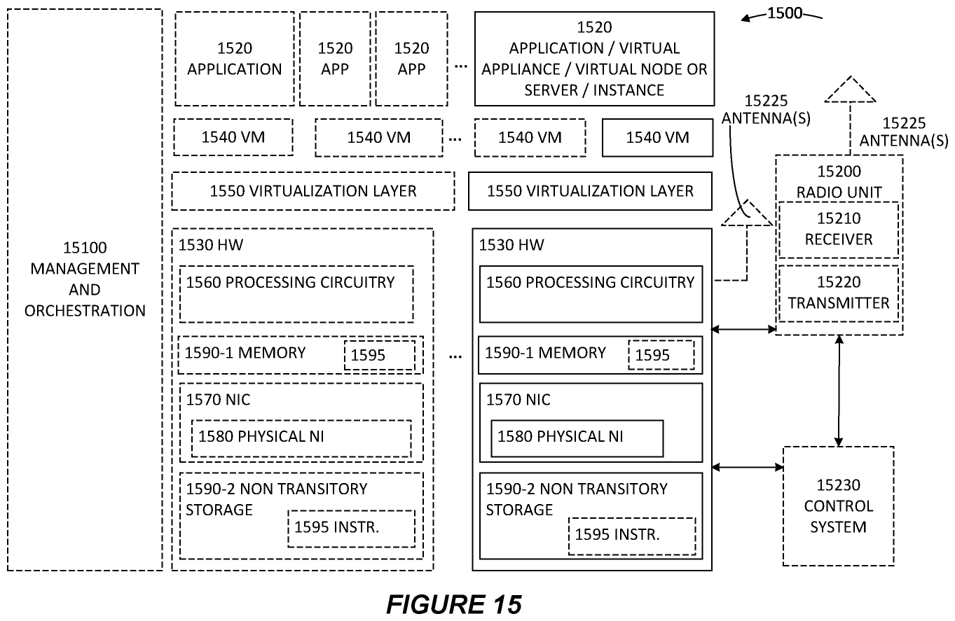

FIG. 15 is a schematic block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1500 hosted by one or more of hardware nodes 1530. Further, in embodiments in which the virtual node is not a radio access node or does not require radio connectivity (e.g., a core network node), then the network node may be entirely virtualized.

The functions may be implemented by one or more applications 1520 (which may alternatively be called software instances, virtual appliances, network functions, virtual nodes, virtual network functions, etc.) operative to implement some of the features, functions, and/or benefits of some of the embodiments disclosed herein. Applications 1520 are run in virtualization environment 1500 which provides hardware 1530 comprising processing circuitry 1560 and memory 1590. Memory 1590 contains instructions 1595 executable by processing circuitry 1560 whereby application 1520 is operative to provide one or more of the features, benefits, and/or functions disclosed herein.

Virtualization environment 1500, comprises general-purpose or special-purpose network hardware devices 1530 comprising a set of one or more processors or processing circuitry 1560, which may be commercial off-the-shelf (COTS) processors, dedicated Application Specific Integrated Circuits (ASICs), or any other type of processing circuitry including digital or analog hardware components or special purpose processors. Each hardware device may comprise memory 1590-1 which may be non-persistent memory for temporarily storing instructions 1595 or software executed by processing circuitry 1560. Each hardware device may comprise one or more network interface controllers (NICs) 1570, also known as network interface cards, which include physical network interface 1580. Each hardware device may also include non-transitory, persistent, machine-readable storage media 1590-2 having stored therein software 1595 and/or instructions executable by processing circuitry 1560. Software 1595 may include any type of software including software for instantiating one or more virtualization layers 1550 (also referred to as hypervisors), software to execute virtual machines 1540 as well as software allowing it to execute functions, features and/or benefits described in relation with some embodiments described herein.

Virtual machines 1540, comprise virtual processing, virtual memory, virtual networking or interface and virtual storage, and may be run by a corresponding virtualization layer 1550 or hypervisor. Different embodiments of the instance of virtual appliance 1520 may be implemented on one or more of virtual machines 1540, and the implementations may be made in different ways.

During operation, processing circuitry 1560 executes software 1595 to instantiate the hypervisor or virtualization layer 1550, which may sometimes be referred to as a virtual machine monitor (VMM). Virtualization layer 1550 may present a virtual operating platform that appears like networking hardware to virtual machine 1540.

As shown in FIG. 15, hardware 1530 may be a standalone network node with generic or specific components. Hardware 1530 may comprise antenna 15225 and may implement some functions via virtualization. Alternatively, hardware 1530 may be part of a larger cluster of hardware (e.g. such as in a data center or customer premise equipment (CPE)) where many hardware nodes work together and are managed via management and orchestration (MANO) 15100, which, among others, oversees lifecycle management of applications 1520.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1540 may be a software implementation of a physical machine that runs programs as if they were executing on a physical, non-virtualized machine. Each of virtual machines 1540, and that part of hardware 1530 that executes that virtual machine, be it hardware dedicated to that virtual machine and/or hardware shared by that virtual machine with others of the virtual machines 1540, forms a separate virtual network elements (VNE).

Still in the context of NFV, Virtual Network Function (VNF) is responsible for handling specific network functions that run in one or more virtual machines 1540 on top of hardware networking infrastructure 1530 and corresponds to application 1520 in FIG. 15.

In some embodiments, one or more radio units 15200 that each include one or more transmitters 15220 and one or more receivers 15210 may be coupled to one or more antennas 15225. Radio units 15200 may communicate directly with hardware nodes 1530 via one or more appropriate network interfaces and may be used in combination with the virtual components to provide a virtual node with radio capabilities, such as a radio access node or a base station.

In some embodiments, some signalling can be effected with the use of control system 15230 which may alternatively be used for communication between the hardware nodes 1530 and radio units 15200.

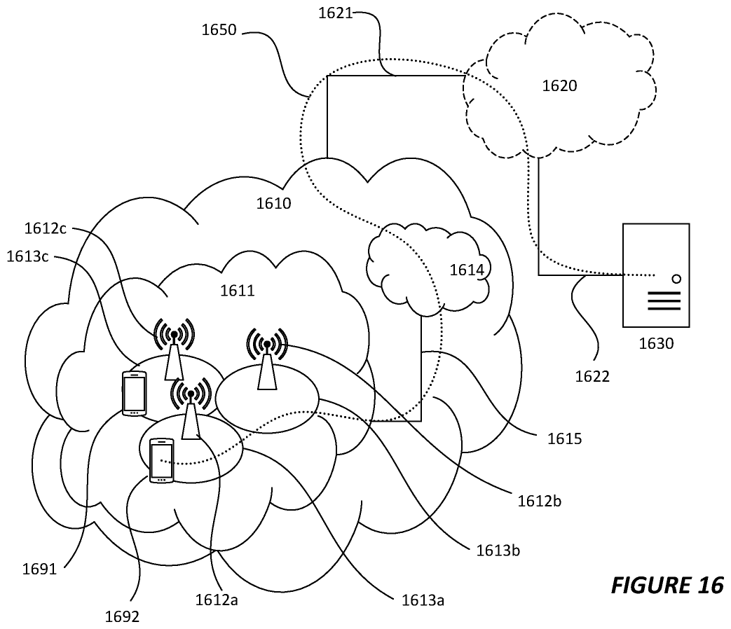

FIG. 16 illustrates a telecommunication network connected via an intermediate network to a host computer in accordance with some embodiments. In particular, with reference to FIG. 16, in accordance with an embodiment, a communication system includes telecommunication network 1610, such as a 3GPP-type cellular network, which comprises access network 1611, such as a radio access network, and core network 1614. Access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to core network 1614 over a wired or wireless connection 1615. A first UE 1691 located in coverage area 1613c is configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the corresponding base station 1612.

Telecommunication network 1610 is itself connected to host computer 1630, which may be embodied in the hardware and/or software of a standalone server, a cloud-implemented server, a distributed server or as processing resources in a server farm. Host computer 1630 may be under the ownership or control of a service provider, or may be operated by the service provider or on behalf of the service provider. Connections 1621 and 1622 between telecommunication network 1610 and host computer 1630 may extend directly from core network 1614 to host computer 1630 or may go via an optional intermediate network 1620. Intermediate network 1620 may be one of, or a combination of more than one of, a public, private or hosted network; intermediate network 1620, if any, may be a backbone network or the Internet; in particular, intermediate network 1620 may comprise two or more sub-networks (not shown).

The communication system of FIG. 16 as a whole enables connectivity between the connected UEs 1691, 1692 and host computer 1630. The connectivity may be described as an over-the-top (OTT) connection 1650. Host computer 1630 and the connected UEs 1691, 1692 are configured to communicate data and/or signaling via OTT connection 1650, using access network 1611, core network 1614, any intermediate network 1620 and possible further infrastructure (not shown) as intermediaries. OTT connection 1650 may be transparent in the sense that the participating communication devices through which OTT connection 1650 passes are unaware of routing of uplink and downlink communications. For example, base station 1612 may not or need not be informed about the past routing of an incoming downlink communication with data originating from host computer 1630 to be forwarded (e.g., handed over) to a connected UE 1691. Similarly, base station 1612 need not be aware of the future routing of an outgoing uplink communication originating from the UE 1691 towards the host computer 1630.

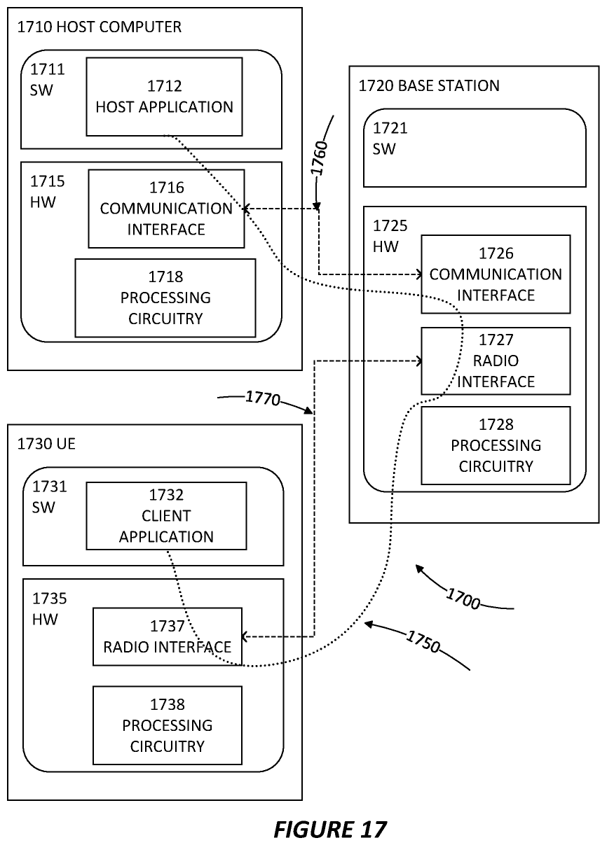

Example implementations, in accordance with an embodiment, of the UE, base station and host computer discussed in the preceding paragraphs will now be described with reference to FIG. 17. FIG. 17 illustrates host computer communicating via a base station with a user equipment over a partially wireless connection in accordance with some embodiments In communication system 1700, host computer 1710 comprises hardware 1715 including communication interface 1716 configured to set up and maintain a wired or wireless connection with an interface of a different communication device of communication system 1700. Host computer 1710 further comprises processing circuitry 1718, which may have storage and/or processing capabilities. In particular, processing circuitry 1718 may comprise one or more programmable processors, application-specific integrated circuits, field programmable gate arrays or combinations of these (not shown) adapted to execute instructions. Host computer 1710 further comprises software 1711, which is stored in or accessible by host computer 1710 and executable by processing circuitry 1718. Software 1711 includes host application 1712. Host application 1712 may be operable to provide a service to a remote user, such as UE 1730 connecting via OTT connection 1750 terminating at UE 1730 and host computer 1710. In providing the service to the remote user, host application 1712 may provide user data which is transmitted using OTT connection 1750.

Communication system 1700 further includes base station 1720 provided in a telecommunication system and comprising hardware 1725 enabling it to communicate with host computer 1710 and with UE 1730. Hardware 1725 may include communication interface 1726 for setting up and maintaining a wired or wireless connection with an interface of a different communication device of communication system 1700, as well as radio interface 1727 for setting up and maintaining at least wireless connection 1770 with UE 1730 located in a coverage area (not shown in FIG. 17) served by base station 1720. Communication interface 1726 may be configured to facilitate connection 1760 to host computer 1710. Connection 1760 may be direct or it may pass through a core network (not shown in FIG. 17) of the telecommunication system and/or through one or more intermediate networks outside the telecommunication system. In the embodiment shown, hardware 1725 of base station 1720 further includes processing circuitry 1728, which may comprise one or more programmable processors, application-specific integrated circuits, field programmable gate arrays or combinations of these (not shown) adapted to execute instructions. Base station 1720 further has software 1721 stored internally or accessible via an external connection.

Communication system 1700 further includes UE 1730 already referred to. Its hardware 1735 may include radio interface 1737 configured to set up and maintain wireless connection 1770 with a base station serving a coverage area in which UE 1730 is currently located. Hardware 1735 of UE 1730 further includes processing circuitry 1738, which may comprise one or more programmable processors, application-specific integrated circuits, field programmable gate arrays or combinations of these (not shown) adapted to execute instructions. UE 1730 further comprises software 1731, which is stored in or accessible by UE 1730 and executable by processing circuitry 1738. Software 1731 includes client application 1732. Client application 1732 may be operable to provide a service to a human or non-human user via UE 1730, with the support of host computer 1710. In host computer 1710, an executing host application 1712 may communicate with the executing client application 1732 via OTT connection 1750 terminating at UE 1730 and host computer 1710. In providing the service to the user, client application 1732 may receive request data from host application 1712 and provide user data in response to the request data. OTT connection 1750 may transfer both the request data and the user data. Client application 1732 may interact with the user to generate the user data that it provides.

It is noted that host computer 1710, base station 1720 and UE 1730 illustrated in FIG. 17 may be similar or identical to host computer 1630, one of base stations 1612a, 1612b, 1612c and one of UEs 1691, 1692 of FIG. 16, respectively. This is to say, the inner workings of these entities may be as shown in FIG. 17 and independently, the surrounding network topology may be that of FIG. 16.

In FIG. 17, OTT connection 1750 has been drawn abstractly to illustrate the communication between host computer 1710 and UE 1730 via base station 1720, without explicit reference to any intermediary devices and the precise routing of messages via these devices. Network infrastructure may determine the routing, which it may be configured to hide from UE 1730 or from the service provider operating host computer 1710, or both. While OTT connection 1750 is active, the network infrastructure may further take decisions by which it dynamically changes the routing (e.g., on the basis of load balancing consideration or reconfiguration of the network).

Wireless connection 1770 between UE 1730 and base station 1720 is in accordance with the teachings of the embodiments described throughout this disclosure. One or more of the various embodiments improve the performance of OTT services provided to UE 1730 using OTT connection 1750, in which wireless connection 1770 forms the last segment. More precisely, the teachings of these embodiments may improve the reliability of uplink transmission as well as the efficiency of carrier switching so as to enhance device power efficiency, and thereby provide benefits such as extended battery lifetime.

A measurement procedure may be provided for the purpose of monitoring data rate, latency and other factors on which the one or more embodiments improve. There may further be an optional network functionality for reconfiguring OTT connection 1750 between host computer 1710 and UE 1730, in response to variations in the measurement results. The measurement procedure and/or the network functionality for reconfiguring OTT connection 1750 may be implemented in software 1711 and hardware 1715 of host computer 1710 or in software 1731 and hardware 1735 of UE 1730, or both. In embodiments, sensors (not shown) may be deployed in or in association with communication devices through which OTT connection 1750 passes; the sensors may participate in the measurement procedure by supplying values of the monitored quantities exemplified above, or supplying values of other physical quantities from which software 1711, 1731 may compute or estimate the monitored quantities. The reconfiguring of OTT connection 1750 may include message format, retransmission settings, preferred routing etc.; the reconfiguring need not affect base station 1720, and it may be unknown or imperceptible to base station 1720. Such procedures and functionalities may be known and practiced in the art. In certain embodiments, measurements may involve proprietary UE signaling facilitating host computer 1710's measurements of throughput, propagation times, latency and the like. The measurements may be implemented in that software 1711 and 1731 causes messages to be transmitted, in particular empty or ‘dummy’ messages, using OTT connection 1750 while it monitors propagation times, errors etc.

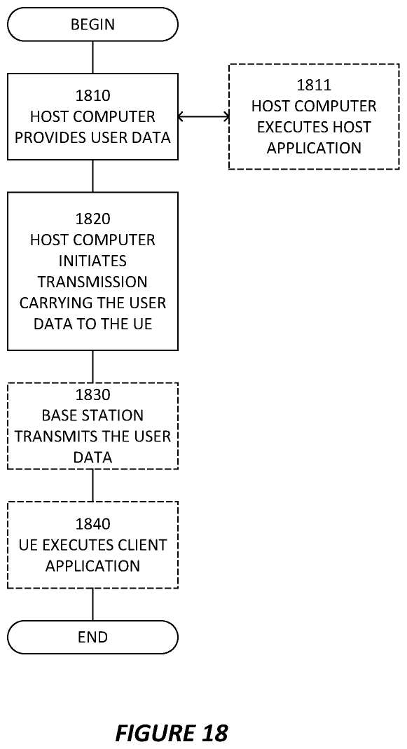

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 1810, the host computer provides user data. In substep 1811 (which may be optional) of step 1810, the host computer provides the user data by executing a host application. In step 1820, the host computer initiates a transmission carrying the user data to the UE. In step 1830 (which may be optional), the base station transmits to the UE the user data which was carried in the transmission that the host computer initiated, in accordance with the teachings of the embodiments described throughout this disclosure. In step 1840 (which may also be optional), the UE executes a client application associated with the host application executed by the host computer.

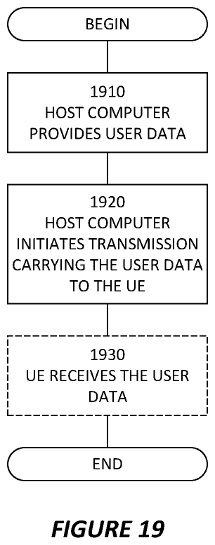

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 1910 of the method, the host computer provides user data. In an optional substep (not shown) the host computer provides the user data by executing a host application. In step 1920, the host computer initiates a transmission carrying the user data to the UE. The transmission may pass via the base station, in accordance with the teachings of the embodiments described throughout this disclosure. In step 1930 (which may be optional), the UE receives the user data carried in the transmission.

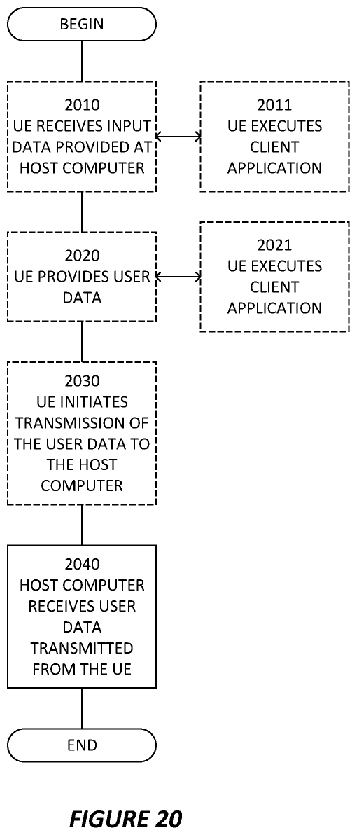

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 2010 (which may be optional), the UE receives input data provided by the host computer. Additionally or alternatively, in step 2020, the UE provides user data. In substep 2021 (which may be optional) of step 2020, the UE provides the user data by executing a client application. In substep 2011 (which may be optional) of step 2010, the UE executes a client application which provides the user data in reaction to the received input data provided by the host computer. In providing the user data, the executed client application may further consider user input received from the user. Regardless of the specific manner in which the user data was provided, the UE initiates, in substep 2030 (which may be optional), transmission of the user data to the host computer. In step 2040 of the method, the host computer receives the user data transmitted from the UE, in accordance with the teachings of the embodiments described throughout this disclosure.

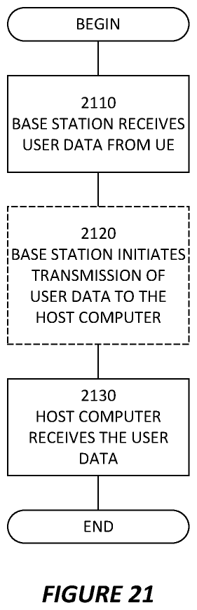

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 2110 (which may be optional), in accordance with the teachings of the embodiments described throughout this disclosure, the base station receives user data from the UE. In step 2120 (which may be optional), the base station initiates transmission of the received user data to the host computer. In step 2130 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Example embodiments of the techniques and apparatus described herein include, but are not limited to, the following enumerated examples:

### Group A Embodiments

A1. A method performed by a wireless device, the method comprising:
obtaining a measure of channel occupancy within and/or clear channel assessment failure within an unlicensed frequency band within which an unlicensed uplink carrier of a cell is deployed;
selecting, from among the unlicensed uplink carrier of the cell and a licensed uplink carrier of the cell, an uplink carrier on which to perform one or more uplink transmissions, based on the obtained measure; and
performing the one or more uplink transmissions on the selected uplink carrier.
   A2. The method of embodiment A1, wherein said selecting comprises selecting the licensed uplink carrier if the obtained measure is greater than an occupancy or failure threshold.
   A3. The method of any of embodiments A1-A2, wherein said selecting is further based on a channel quality metric for the unlicensed frequency band, and wherein said selecting comprises selecting the licensed uplink carrier or the unlicensed uplink carrier depending respectively on whether:
the channel quality metric is less than a quality threshold or the obtained measure is greater than an occupancy or failure threshold; or
the channel quality metric is greater than the quality threshold and the obtained measure is less than the occupancy or failure threshold.
   A4. The method of embodiment A3, wherein the channel quality metric is a reference signal received power of a downlink pathloss reference.
   A5. The method of any of embodiments A2-A4, further comprising receiving signaling indicating the occupancy or failure threshold.
   A6. The method of embodiment A5, wherein the signaling is received in a handover command that commands the wireless device to hand over to the cell.
   A7. The method of any of embodiments A1-A6, wherein the obtained measure is a function of:
a ratio of failed clear channel assessments to total clear channel assessments;
a number of consecutive clear channel assessment failures; and/or
a level of channel occupancy.
   A8. The method of any of embodiments A1-A7, wherein the obtained measure is per channel, subband, or bandwidth part within the unlicensed frequency band such that the obtained measure comprises, for each channel, subband, or bandwidth part of the unlicensed uplink carrier, a measure of channel occupancy on and/or clear channel assessment failure on that channel, subband, or bandwidth part, and wherein said selecting comprises selecting the licensed uplink carrier if the obtained measure for each channel, subband, or bandwidth part of the unlicensed uplink carrier is greater than the occupancy or failure threshold.
   A9. The method of any of embodiments A1-A8, wherein the one or more uplink transmissions are associated with a certain service or channel access priority class, CAPC, and wherein the obtained measure is for the certain service or CAPC.
   A10. The method of any of embodiments A1-A9, wherein the one or more uplink transmissions are one or more transmissions of a random access procedure, a physical uplink shared channel, or a physical uplink control channel.
   A11. The method of any of embodiments A1-A10, wherein said obtaining comprises measuring channel occupancy on and/or clear channel assessment failure on the unlicensed uplink carrier.
   A12. The method of any of embodiments A1-A11, wherein said obtaining comprises receiving signaling indicating channel occupancy on and/or clear channel assessment failure on the unlicensed uplink carrier as measured by a radio network node serving the cell.
   A13. The method of any of embodiments A1-A12, wherein the measure is a function of a measure of channel occupancy on and/or clear channel assessment failure on the unlicensed uplink carrier.
   A14. The method of any of embodiments A1-A12, wherein the measure is a function of a measure of channel occupancy on and/or clear channel assessment failure on an unlicensed downlink carrier deployed within the unlicensed frequency band.
   A15. The method of any of embodiments A1-A14, wherein the measure is a function of a duration between when an uplink or downlink transmission is triggered at a medium access control, MAC, protocol layer and when the uplink or downlink transmission is transmitted at a physical protocol layer.
   A16. The method of any of embodiments A1-A15, wherein the measure is a function of a duration since the wireless device last detected a downlink reference signal in the cell.
   A17. The method of any of embodiments A1-A16, further comprising receiving signaling indicating the wireless device is to or is allowed to perform the one or more uplink transmissions on the unlicensed uplink carrier, wherein the signaling also indicates that the wireless device is allowed to instead perform the one or more uplink transmissions on the licensed uplink carrier if one or more conditions are fulfilled.
   A18. The method of any of embodiments A1-A17, further comprising transmitting, to a radio network node serving the cell, a request to perform the one or more uplink transmissions on the selected uplink carrier, and wherein said performing comprises performing the one or more uplink transmissions on the selected uplink carrier responsive to receiving a response that grants the request.
   A19. The method of embodiment A18, wherein transmitting the request comprises transmitting:
a sounding reference signal on the licensed uplink carrier;
a physical uplink control channel transmission on the licensed uplink carrier;
a random access transmission on the licensed uplink carrier;
a medium access control, MAC, control element, CE, on the licensed uplink carrier; or
a radio resource control, RRC, message on the licensed uplink carrier.
   A20. The method of any of embodiments A1-A19, further comprising transmitting, to a network node, a report that indicates the obtained measure and/or that indicates occurrence of an event based on the obtained measure.
   A21. The method of embodiment A20, wherein the report is transmitted on the licensed uplink carrier.
   A22. The method of any of embodiments A1-A21, wherein the unlicensed uplink carrier is a New Radio, NR, unlicensed uplink carrier, and wherein the licensed uplink carrier is a supplementary uplink carrier.
   AA. The method of any of the previous embodiments, further comprising:
providing user data; and
forwarding the user data to a host computer via the transmission to a base station.

### Group B Embodiments

B1. A method performed by a network node, the method comprising:
obtaining a measure of channel occupancy within and/or clear channel assessment failure within an unlicensed frequency band within which an unlicensed uplink carrier is deployed;
selecting, from among the unlicensed uplink carrier of the cell and a licensed uplink carrier of the cell, an uplink carrier on which a wireless device is to perform one or more uplink transmissions, based on the obtained measure; and
transmitting, to the wireless device, signaling indicating the selected uplink carrier on which the wireless device is to perform the one or more uplink transmissions.
   B2. The method of embodiment B1, wherein said selecting comprises selecting the licensed uplink carrier if the obtained measure is greater than an occupancy or failure threshold.
   B3. The method of any of embodiments B1-B2, wherein said selecting is further based on a channel quality metric for the unlicensed frequency band, and wherein said selecting comprises selecting the licensed uplink carrier or the unlicensed uplink carrier depending respectively on whether:
the channel quality metric is less than a quality threshold or the obtained measure is greater than an occupancy or failure threshold; or
the channel quality metric is greater than the quality threshold and the obtained measure is less than the occupancy or failure threshold.
   B4. The method of embodiment B3, wherein the channel quality metric is a reference signal received power of a downlink pathloss reference.
   B5. The method of any of embodiments B1-B4, wherein the obtained measure is a function of:
a ratio of failed clear channel assessments to total clear channel assessments;
a number of consecutive clear channel assessment failures; and/or
a level of channel occupancy.
   B6. The method of any of embodiments B1-B5, wherein the obtained measure is per channel, subband, or bandwidth part within the unlicensed frequency band such that the obtained measure comprises, for each channel, subband, or bandwidth part of the unlicensed uplink carrier, a measure of channel occupancy on and/or clear channel assessment failure on that channel, subband, or bandwidth part, and wherein said selecting comprises selecting the licensed uplink carrier if the obtained measure for each channel, subband, or bandwidth part of the unlicensed uplink carrier is greater than the occupancy or failure threshold.
   B7. The method of any of embodiments B1-B6, wherein the one or more uplink transmissions are associated with a certain service or channel access priority class, CAPC, and wherein the obtained measure is for the certain service or CAPC.
   B8. The method of any of embodiments B1-B7, wherein the one or more uplink transmissions are one or more transmissions of a random access procedure, a physical uplink shared channel, or a physical uplink control channel.
   B9. The method of any of embodiments B1-B8, wherein said obtaining comprises measuring channel occupancy on and/or clear channel assessment failure on the unlicensed uplink carrier.
   B10. The method of any of embodiments B1-B9, wherein said obtaining comprises receiving signaling indicating channel occupancy on and/or clear channel assessment failure on the unlicensed uplink carrier as measured by the wireless device.
   B11. The method of any of embodiments B1-B10, wherein the measure is a function of a measure of channel occupancy on and/or clear channel assessment failure on the unlicensed uplink carrier.
   B12. The method of any of embodiments B1-B10, wherein the measure is a function of a measure of channel occupancy on and/or clear channel assessment failure on an unlicensed downlink carrier deployed within the unlicensed frequency band.
   B13. The method of any of embodiments B1-B12, wherein the measure is a function of a duration between when an uplink or downlink transmission is triggered at a medium access control, MAC, protocol layer and when the uplink or downlink transmission is transmitted at a physical protocol layer.
   B14. The method of any of embodiments B1-B13, wherein the measure is a function of a duration since the wireless device last detected a downlink reference signal in the cell.
   B15. The method of any of embodiments B1-B14, further comprising transmitting signaling indicating the wireless device is to or is allowed to perform the one or more uplink transmissions on the unlicensed uplink carrier, wherein the signaling also indicates that the wireless device is allowed to instead perform the one or more uplink transmissions on the licensed uplink carrier if one or more conditions are fulfilled.
   B16. The method of any of embodiments B1-b15, further comprising receiving, from the wireless device, a request to perform the one or more uplink transmissions on the licensed uplink carrier or the unlicensed uplink carrier, and wherein said selecting is performed responsive to receiving the request.
   B17. The method of embodiment B16, wherein receiving the request comprises receiving:
a sounding reference signal on the licensed uplink carrier;
a physical uplink control channel transmission on the licensed uplink carrier;
a random access transmission on the licensed uplink carrier;
a medium access control, MAC, control element, CE, on the licensed uplink carrier; or
a radio resource control, RRC, message on the licensed uplink carrier.
   B18. The method of any of embodiments B1-B17, further comprising receiving, from the wireless device, a report that indicates the obtained measure and/or that indicates occurrence of an event based on the obtained measure.
   B19. The method of embodiment B18, wherein the report is received on the licensed uplink carrier.
   B20. The method of any of embodiments B1-B19, wherein the unlicensed uplink carrier is a New Radio, NR, unlicensed uplink carrier, and wherein the licensed uplink carrier is a supplementary uplink carrier.
   BB. The method of any of the previous embodiments, further comprising:
obtaining user data; and
forwarding the user data to a host computer or a wireless device.

### Group C Embodiments

C1. A wireless device configured to perform any of the steps of any of the Group A, E, or G embodiments.
C2. A wireless device comprising processing circuitry configured to perform any of the steps of any of the Group A, E, or G embodiments.
C3. A wireless device comprising:
communication circuitry; and
processing circuitry configured to perform any of the steps of any of the Group A, E, or G embodiments.
   C4. A wireless device comprising:
processing circuitry configured to perform any of the steps of any of the Group A, E, or G embodiments; and
power supply circuitry configured to supply power to the wireless device.
   C5. A wireless device comprising:
processing circuitry and memory, the memory containing instructions executable by the processing circuitry whereby the wireless device is configured to perform any of the steps of any of the Group A, E, or G embodiments.
   C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A, E, or G embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C7. A computer program comprising instructions which, when executed by at least one processor of a wireless device, causes the wireless device to carry out the steps of any of the Group A, E, or G embodiments.
   C8. A carrier containing the computer program of embodiment C7, wherein the carrier is one of an electronic signal, optical signal, radio signal, or computer readable storage medium.
   C9. A network node configured to perform any of the steps of any of the Group B, F, or H embodiments.
   C10. A network node comprising processing circuitry configured to perform any of the steps of any of the Group B, F, or H embodiments.
   C11. A network node comprising:
communication circuitry; and
processing circuitry configured to perform any of the steps of any of the Group B, F, or H embodiments.
   C12. A network node comprising:
processing circuitry configured to perform any of the steps of any of the Group B, F, or H embodiments;
power supply circuitry configured to supply power to the network node.
   C13. A network node comprising:
processing circuitry and memory, the memory containing instructions executable by the processing circuitry whereby the network node is configured to perform any of the steps of any of the Group B, F, or H embodiments.
   C14. The network node of any of embodiments C9-C13, wherein the network node is a base station.
   C15. A computer program comprising instructions which, when executed by at least one processor of a network node, causes the network node to carry out the steps of any of the Group B, F, or H embodiments.
   C16. The computer program of embodiment C14, wherein the network node is a base station.
   C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B, F, or H embodiments.
   D2. The communication system of the previous embodiment further including the base station.
   D3. The communication system of the previous 2 embodiments, further including the UE, wherein the UE is configured to communicate with the base station.
   D4. The communication system of the previous 3 embodiments, wherein:
the processing circuitry of the host computer is configured to execute a host application, thereby providing the user data; and
the UE comprises processing circuitry configured to execute a client application associated with the host application.
   D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B, F, or H embodiments.
   D6. The method of the previous embodiment, further comprising, at the base station, transmitting the user data.
   D7. The method of the previous 2 embodiments, wherein the user data is provided at the host computer by executing a host application, the method further comprising, at the UE, executing a client application associated with the host application.
   D8. A user equipment (UE) configured to communicate with a base station, the UE comprising a radio interface and processing circuitry configured to perform any of the previous 3 embodiments.
   D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A, E, or G embodiments.
   D10. The communication system of the previous embodiment, wherein the cellular network further includes a base station configured to communicate with the UE.
   D11. The communication system of the previous 2 embodiments, wherein:
the processing circuitry of the host computer is configured to execute a host application, thereby providing the user data; and
the UE's processing circuitry is configured to execute a client application associated with the host application.
   D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A, E, or G embodiments.
   D13. The method of the previous embodiment, further comprising at the UE, receiving the user data from the base station.
   D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A, E, or G embodiments.
   D15. The communication system of the previous embodiment, further including the UE.
   D16. The communication system of the previous 2 embodiments, further including the base station, wherein the base station comprises a radio interface configured to communicate with the UE and a communication interface configured to forward to the host computer the user data carried by a transmission from the UE to the base station.
   D17. The communication system of the previous 3 embodiments, wherein:
the processing circuitry of the host computer is configured to execute a host application; and
the UE's processing circuitry is configured to execute a client application associated with the host application, thereby providing the user data.
   D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   D19. A method implemented in a communication system including a host computer, a base station and a user equipment (UE), the method comprising:
at the host computer, receiving user data transmitted to the base station from the UE, wherein the UE performs any of the steps of any of the Group A, E, or G embodiments.
   D20. The method of the previous embodiment, further comprising, at the UE, providing the user data to the base station.
   D21. The method of the previous 2 embodiments, further comprising:
at the UE, executing a client application, thereby providing the user data to be transmitted; and
at the host computer, executing a host application associated with the client application.
   D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B, F, or H embodiments.
   D24. The communication system of the previous embodiment further including the base station.
   D25. The communication system of the previous 2 embodiments, further including the UE, wherein the UE is configured to communicate with the base station.
   D26. The communication system of the previous 3 embodiments, wherein:
the processing circuitry of the host computer is configured to execute a host application;
the UE is configured to execute a client application associated with the host application, thereby providing the user data to be received by the host computer.
   D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A, E, or G embodiments.
   D28. The method of the previous embodiment, further comprising at the base station, receiving the user data from the UE.
   D29. The method of the previous 2 embodiments, further comprising at the base station, initiating a transmission of the received user data to the host computer.

### Group E Embodiments

E1. A method performed by a wireless device, the method comprising:
transmitting, to a network node, a report that indicates information about channel occupancy within and/or clear channel assessment failure within an unlicensed frequency band within which an unlicensed uplink carrier of a cell is deployed.
   E2. The method of embodiment E1, wherein the report indicates a measure of the channel occupancy within and/or clear channel assessment failure within the unlicensed frequency band.
   E3. The method of any of embodiments E1-E2, wherein the report indicates occurrence of an event based on a measure of the channel occupancy within and/or clear channel assessment failure within the unlicensed frequency band.
   E4. The method of any of embodiments E1-E3, wherein the report indicates occurrence of an event, wherein the event comprises a measure of the channel occupancy within and/or clear channel assessment failure within the unlicensed frequency band exceeding an occupancy or failure threshold.
   E5. The method of any of embodiments E2-E4, wherein the measure is a function of:
a ratio of failed clear channel assessments to total clear channel assessments;
a number of consecutive clear channel assessment failures; and/or
a level of channel occupancy.
   E6. The method of any of embodiments E2-E5, wherein the measure is a function of a measure of channel occupancy on and/or clear channel assessment failure on the unlicensed uplink carrier.
   E7. The method of any of embodiments E2-E6, wherein the measure is a function of a measure of channel occupancy on and/or clear channel assessment failure on an unlicensed downlink carrier deployed within the unlicensed frequency band.
   E8. The method of any of embodiments E1-E7, wherein the measure is a function of a duration between when an uplink or downlink transmission is triggered at a medium access control, MAC, protocol layer and when the uplink or downlink transmission is transmitted at a physical protocol layer.
   E9. The method of any of embodiments E1-E8, wherein the measure is a function of a duration since the wireless device last detected a downlink reference signal in the cell.
   E10. The method of any of embodiments E1-E9, wherein the report is transmitted by, in conjunction with, or is included in:
a sounding reference signal on the licensed uplink carrier;
a physical uplink control channel transmission on the licensed uplink carrier;
a random access transmission on the licensed uplink carrier;
a medium access control, MAC, control element, CE, on the licensed uplink carrier; or
a radio resource control, RRC, message on the licensed uplink carrier.
   E11. The method of any of embodiments E1-E10, wherein the report is transmitted on a licensed uplink carrier.
   E12. The method of any of embodiments E1-E11, further comprising selecting a channel, subband, bandwidth part, or uplink carrier on which to perform one or more uplink transmissions, based on the channel occupancy within and/or clear channel assessment failure within the unlicensed frequency band.
   E13. The method of embodiment E12, wherein said selecting comprises selecting, from among multiple channels or subbands on the unlicensed uplink carrier, a channel or subband on which to perform the one or more uplink transmissions.
   E14. The method of embodiment E12, wherein said selecting comprises selecting, from among multiple bandwidth parts on the unlicensed uplink carrier, a bandwidth part on which to perform the one or more uplink transmissions.
   E15. The method of embodiment E12, wherein said selecting comprises selecting, from among the unlicensed uplink carrier of the cell and a licensed uplink carrier of the cell, an uplink carrier on which to perform the one or more uplink transmissions.
   E16. The method of any of embodiments E12-E15, further comprising performing the one or more uplink transmissions in accordance with the selecting.
   E17. The method of any of embodiments E12-E15, wherein the one or more uplink transmissions are one or more transmissions of a random access procedure, a physical uplink shared channel, or a physical uplink control channel.
   E18. The method of any of embodiments E1-E17, wherein the report comprises or is accompanied by a request by the wireless device to switch a channel, subband, bandwidth part, or uplink carrier on which to perform one or more uplink transmissions.
   E19. The method of any of embodiments E1-E18, wherein the report is for a certain service or channel access priority class, CAPC.
   E20. The method of any of embodiments E1-E19, wherein the unlicensed uplink carrier is a New Radio, NR, unlicensed uplink carrier.
   EE. The method of any of the previous embodiments, further comprising:
providing user data; and
forwarding the user data to a host computer via the transmission to a base station.

### Group F Embodiments

F1. A method performed by a network node, the method comprising:
receiving, from a wireless device, a report that indicates information about channel occupancy within and/or clear channel assessment failure within an unlicensed frequency band within which an unlicensed uplink carrier of a cell is deployed.
   F2. The method of embodiment F1, wherein the report indicates a measure of the channel occupancy within and/or clear channel assessment failure within the unlicensed frequency band.
   F3. The method of any of embodiments F1-F2, wherein the report indicates occurrence of an event based on a measure of the channel occupancy within and/or clear channel assessment failure within the unlicensed frequency band.
   F4. The method of any of embodiments F1-F3, wherein the report indicates occurrence of an event, wherein the event comprises a measure of the channel occupancy within and/or clear channel assessment failure within the unlicensed frequency band exceeding an occupancy or failure threshold.
   F5. The method of any of embodiments F2-F4, wherein the measure is a function of:
a ratio of failed clear channel assessments to total clear channel assessments;
a number of consecutive clear channel assessment failures; and/or
a level of channel occupancy.
   F6. The method of any of embodiments F2-F5, wherein the measure is a function of a measure of channel occupancy on and/or clear channel assessment failure on the unlicensed uplink carrier.
   F7. The method of any of embodiments F2-F6, wherein the measure is a function of a measure of channel occupancy on and/or clear channel assessment failure on an unlicensed downlink carrier deployed within the unlicensed frequency band.
   F8. The method of any of embodiments F1-F7, wherein the measure is a function of a duration between when an uplink or downlink transmission is triggered at a medium access control, MAC, protocol layer and when the uplink or downlink transmission is transmitted at a physical protocol layer.
   F9. The method of any of embodiments F1-F8, wherein the measure is a function of a duration since the wireless device last detected a downlink reference signal in the cell.
   F10. The method of any of embodiments F1-F9, wherein the report is transmitted by, in conjunction with, or is included in:
a sounding reference signal on the licensed uplink carrier;
a physical uplink control channel transmission on the licensed uplink carrier;
a random access transmission on the licensed uplink carrier;
a medium access control, MAC, control element, CE, on the licensed uplink carrier; or
a radio resource control, RRC, message on the licensed uplink carrier.
   F11. The method of any of embodiments F1-F10, wherein the report is transmitted on a licensed uplink carrier.
   F12. The method of any of embodiments F1-F11, further comprising selecting a channel, subband, bandwidth part, or uplink carrier on which the wireless device is to perform one or more uplink transmissions, based on the channel occupancy within and/or clear channel assessment failure within the unlicensed frequency band.
   F13. The method of embodiment F12, wherein said selecting comprises selecting, from among multiple channels or subbands on the unlicensed uplink carrier, a channel or subband on which the wireless device is to perform the one or more uplink transmissions.
   F14. The method of embodiment F12, wherein said selecting comprises selecting, from among multiple bandwidth parts on the unlicensed uplink carrier, a bandwidth part on which the wireless device is to perform the one or more uplink transmissions.
   F15. The method of embodiment F12, wherein said selecting comprises selecting, from among the unlicensed uplink carrier of the cell and a licensed uplink carrier of the cell, an uplink carrier on which the wireless device is to perform the one or more uplink transmissions.
   F16. The method of any of embodiments F12-F15, further comprising receiving the one or more uplink transmissions in accordance with the selecting.
   F17. The method of any of embodiments F12-F15, wherein the one or more uplink transmissions are one or more transmissions of a random access procedure, a physical uplink shared channel, or a physical uplink control channel.
   F18. The method of any of embodiments F1-F17, wherein the report comprises or is accompanied by a request by the wireless device to switch a channel, subband, bandwidth part, or uplink carrier on which to perform one or more uplink transmissions.
   F19. The method of any of embodiments F1-F18, wherein the report is for a certain service or channel access priority class, CAPC.
   F20. The method of any of embodiments F1-F10, wherein the unlicensed uplink carrier is a New Radio, NR, unlicensed uplink carrier.
   F21. The method of any of embodiments F12-F17, further comprising transmitting signaling to the wireless device indicating the selected channel, subband, bandwidth part, or uplink carrier on which the wireless device is to perform one or more uplink transmissions.

### Group G Embodiments

G1. A method performed by a wireless device, the method comprising:
transmitting, to a network node, a request to switch from an unlicensed uplink carrier of a cell to a licensed uplink carrier of the cell.
   G2. The method of embodiment G1, further comprising determining to transmit the request based on channel occupancy within and/or clear channel assessment failure within an unlicensed frequency band within which the unlicensed uplink carrier of the cell is deployed.
   G3. The method of embodiment G2, wherein said determining comprises determining to transmit the report when an event occurs, wherein the event is based on the channel occupancy within and/or clear channel assessment failure within the unlicensed frequency band.
   G4. The method of embodiment G3, wherein the event comprises a measure of the channel occupancy within and/or clear channel assessment failure within the unlicensed frequency band exceeding an occupancy or failure threshold.
   G5. The method of any of embodiments G1-G4, wherein the request indicates or is accompanied by a measure of channel occupancy within and/or clear channel assessment failure within an unlicensed frequency band within which the unlicensed uplink carrier of the cell is deployed.
   G6. The method of any of embodiments G4-G5, wherein the measure is a function of:
a ratio of failed clear channel assessments to total clear channel assessments;
a number of consecutive clear channel assessment failures; and/or
a level of channel occupancy.
   G7. The method of any of embodiments G4-G6, wherein the measure is a function of a measure of channel occupancy on and/or clear channel assessment failure on the unlicensed uplink carrier.
   G8. The method of any of embodiments G4-G7, wherein the measure is a function of a measure of channel occupancy on and/or clear channel assessment failure on an unlicensed downlink carrier deployed within the unlicensed frequency band.
   G9. The method of any of embodiments G4-G8, wherein the measure is a function of a duration between when an uplink or downlink transmission is triggered at a medium access control, MAC, protocol layer and when the uplink or downlink transmission is transmitted at a physical protocol layer.
   G10. The method of any of embodiments G4-G9, wherein the measure is a function of a duration since the wireless device last detected a downlink reference signal in the cell.
   G11. The method of any of embodiments G1-G10, wherein the request is transmitted by, in conjunction with, or is included in:
a sounding reference signal on the licensed uplink carrier;
a physical uplink control channel transmission on the licensed uplink carrier;
a random access transmission on the licensed uplink carrier;
a medium access control, MAC, control element, CE, on the licensed uplink carrier; or
a radio resource control, RRC, message on the licensed uplink carrier.
   G12. The method of any of embodiments G1-G11, wherein the request is transmitted on a licensed uplink carrier.
   G13. The method of any of embodiments G1-G12, further comprising receiving a response that grants or denies the request.
   G14. The method of embodiment G13, further comprising performing one or more uplink transmissions on the licensed uplink carrier, responsive to receiving a response that grants the request.
   G15. The method of embodiment G14, wherein the one or more uplink transmissions are one or more transmissions of a random access procedure, a physical uplink shared channel, or a physical uplink control channel.
   G16. The method of any of the previous embodiments, further comprising:
providing user data; and
forwarding the user data to a host computer via the transmission to a base station.
   G17. The method of any of embodiments G1-G16, wherein the unlicensed uplink carrier is a New Radio, NR, unlicensed uplink carrier, and wherein the licensed uplink carrier is a supplementary uplink carrier.

### Group H Embodiments

H1. A method performed by a network node, the method comprising:
receiving, from a wireless device, a request to switch from an unlicensed uplink carrier of a cell to a licensed uplink carrier of the cell.
   H2. The method of embodiment H1, further comprising determining whether to grant or deny the request based on channel occupancy within and/or clear channel assessment failure within an unlicensed frequency band within which the unlicensed uplink carrier of the cell is deployed.
   H3. The method of any of embodiments H1-H2, wherein the request indicates or is accompanied by an indication that an event has occurred, wherein the event is based on the channel occupancy within and/or clear channel assessment failure within the unlicensed frequency band.
   H4. The method of embodiment H3, wherein the event comprises a measure of the channel occupancy within and/or clear channel assessment failure within the unlicensed frequency band exceeding an occupancy or failure threshold.
   H5. The method of any of embodiments H1-H4, wherein the request indicates or is accompanied by a measure of channel occupancy within and/or clear channel assessment failure within an unlicensed frequency band within which the unlicensed uplink carrier of the cell is deployed.
   H6. The method of any of embodiments H4-H5, wherein the measure is a function of:
a ratio of failed clear channel assessments to total clear channel assessments;
a number of consecutive clear channel assessment failures; and/or
a level of channel occupancy.
   H7. The method of any of embodiments H4-H6, wherein the measure is a function of a measure of channel occupancy on and/or clear channel assessment failure on the unlicensed uplink carrier.
   H8. The method of any of embodiments H4-H7, wherein the measure is a function of a measure of channel occupancy on and/or clear channel assessment failure on an unlicensed downlink carrier deployed within the unlicensed frequency band.
   H9. The method of any of embodiments H4-H8, wherein the measure is a function of a duration between when an uplink or downlink transmission is triggered at a medium access control, MAC, protocol layer and when the uplink or downlink transmission is transmitted at a physical protocol layer.
   H10. The method of any of embodiments H4-H9, wherein the measure is a function of a duration since the wireless device last detected a downlink reference signal in the cell.
   H11. The method of any of embodiments H1-H10, wherein the request is received by, in conjunction with, or is included in:
a sounding reference signal on the licensed uplink carrier;
a physical uplink control channel transmission on the licensed uplink carrier;
a random access transmission on the licensed uplink carrier;
a medium access control, MAC, control element, CE, on the licensed uplink carrier; or
a radio resource control, RRC, message on the licensed uplink carrier.
   H12. The method of any of embodiments H1-H11, wherein the request is received on a licensed uplink carrier.
   H13. The method of any of embodiments H1-H12, further comprising transmitting a response that grants or denies the request.
   H14. The method of embodiment H13, further comprising receiving one or more uplink transmissions on the licensed uplink carrier, responsive to transmitting a response that grants the request.
   H15. The method of embodiment H14, wherein the one or more uplink transmissions are one or more transmissions of a random access procedure, a physical uplink shared channel, or a physical uplink control channel.
   H16. The method of any of embodiments H1-H15, wherein the unlicensed uplink carrier is a New Radio, NR, unlicensed uplink carrier, and wherein the licensed uplink carrier is a supplementary uplink carrier.

1.-38. (canceled)

39. A method performed by a wireless device, the method comprising:
obtaining a measure of channel occupancy within and/or clear channel assessment failure within an unlicensed frequency band within which an unlicensed uplink carrier of a cell is deployed;
selecting, from among the unlicensed uplink carrier of the cell and a licensed uplink carrier of the cell, an uplink carrier on which to perform one or more uplink transmissions, based on the obtained measure, wherein the measure is a function of channel occupancy on and/or clear channel assessment failure on the unlicensed uplink carrier; and
performing the one or more uplink transmissions on the selected uplink carrier.

40. The method of claim 39, wherein said selecting comprises selecting the licensed uplink carrier if the obtained measure is greater than an occupancy or failure threshold.

41. The method of claim 39, wherein said selecting is further based on a channel quality metric for the unlicensed frequency band, and wherein said selecting comprises selecting the licensed uplink carrier or the unlicensed uplink carrier depending respectively on whether:
the channel quality metric is less than a quality threshold or the obtained measure is greater than an occupancy or failure threshold; or
the channel quality metric is greater than the quality threshold and the obtained measure is less than the occupancy or failure threshold.

42. The method of claim 41, further comprising receiving signaling indicating the occupancy or failure threshold, wherein the signaling is received in a handover command that commands the wireless device to hand over to the cell.

43. The method of claim 39, wherein the obtained measure is a function of:
a ratio of failed clear channel assessments to total clear channel assessments;
a number of consecutive clear channel assessment failures; and/or
a level of channel occupancy.

44. The method of claim 39, wherein the obtained measure is per channel, subband, or bandwidth part within the unlicensed frequency band such that the obtained measure comprises, for each channel, subband, or bandwidth part of the unlicensed uplink carrier, a measure of channel occupancy on and/or clear channel assessment failure on that channel, subband, or bandwidth part, and wherein said selecting comprises selecting the licensed uplink carrier if the obtained measure for each channel, subband, or bandwidth part of the unlicensed uplink carrier is greater than the occupancy or failure threshold.

45. The method of claim 39, wherein the measure is a function of:
a duration between when an uplink or downlink transmission is triggered at a medium access control (MAC) protocol layer and when the uplink or downlink transmission is transmitted at a physical protocol layer; or
a duration since the wireless device last detected a downlink reference signal in the cell.

46. The method of claim 39, further comprising receiving signaling indicating the wireless device is to or is allowed to perform the one or more uplink transmissions on the unlicensed uplink carrier, wherein the signaling also indicates that the wireless device is allowed to instead perform the one or more uplink transmissions on the licensed uplink carrier if one or more conditions are fulfilled.

47. The method of claim 39, further comprising transmitting, to a radio network node serving the cell, a request to perform the one or more uplink transmissions on the selected uplink carrier, and wherein said performing comprises performing the one or more uplink transmissions on the selected uplink carrier responsive to receiving a response that grants the request.

48. The method of claim 47, wherein transmitting the request comprises transmitting:
a sounding reference signal on the licensed uplink carrier;
a physical uplink control channel transmission on the licensed uplink carrier;
a random access transmission on the licensed uplink carrier;
a medium access control (MAC) control element (CE) on the licensed uplink carrier; or
a radio resource control (RRC) message on the licensed uplink carrier.

49. The method of claim 39, further comprising:
for each channel, subband, or bandwidth part of the unlicensed uplink carrier, obtaining a measure of channel occupancy on and/or clear channel assessment failure on that channel, subband, or bandwidth part;
based on the measure of channel occupancy on and/or clear channel assessment failure on each channel, subband, or bandwidth part, selecting a channel, subband, or bandwidth part on which to perform one or more uplink transmissions; and
performing one or more uplink transmissions on the selected channel, subband, or bandwidth part.

50. The method of claim 39, wherein the unlicensed uplink carrier is a New Radio (NR) unlicensed uplink carrier, and wherein the licensed uplink carrier is a supplementary uplink carrier.

51. A method performed by a network node, the method comprising:
receiving, from a wireless device, a report that indicates a measure of channel occupancy within and/or clear channel assessment failure within an unlicensed frequency band within which an unlicensed uplink carrier is deployed;
selecting, from among the unlicensed uplink carrier of the cell and a licensed uplink carrier of the cell, an uplink carrier on which the wireless device is to perform one or more uplink transmissions, based on the obtained measure; wherein the measure is a function of a measure of channel occupancy on and/or clear channel assessment failure on the unlicensed uplink carrier; and
transmitting, to the wireless device, signaling indicating the selected uplink carrier on which the wireless device is to perform the one or more uplink transmissions.

52. The method of claim 51, wherein said selecting comprises selecting the licensed uplink carrier if the obtained measure is greater than an occupancy or failure threshold.

53. The method of claim 51, wherein said selecting is further based on a channel quality metric for the unlicensed frequency band, and wherein said selecting comprises selecting the licensed uplink carrier or the unlicensed uplink carrier depending respectively on whether:
the channel quality metric is less than a quality threshold or the obtained measure is greater than an occupancy or failure threshold; or
the channel quality metric is greater than the quality threshold and the obtained measure is less than the occupancy or failure threshold.

54. The method of claim 51, wherein the obtained measure is a function of:
a ratio of failed clear channel assessments to total clear channel assessments;
a number of consecutive clear channel assessment failures; and/or
a level of channel occupancy.

55. The method of claim 51, wherein the obtained measure is per channel, subband, or bandwidth part within the unlicensed frequency band such that the obtained measure comprises, for each channel, subband, or bandwidth part of the unlicensed uplink carrier, a measure of channel occupancy on and/or clear channel assessment failure on that channel, subband, or bandwidth part, and wherein said selecting comprises selecting the licensed uplink carrier if the obtained measure for each channel, subband, or bandwidth part of the unlicensed uplink carrier is greater than the occupancy or failure threshold.

56. The method of claim 51, wherein the measure is a function of:
a duration between when an uplink or downlink transmission is triggered at a medium access control (MAC) protocol layer and when the uplink or downlink transmission is transmitted at a physical protocol layer; or
a duration since the wireless device last detected a downlink reference signal in the cell.

57. The method of claim 51, further comprising transmitting signaling indicating the wireless device is to or is allowed to perform the one or more uplink transmissions on the unlicensed uplink carrier, wherein the signaling also indicates that the wireless device is allowed to instead perform the one or more uplink transmissions on the licensed uplink carrier if one or more conditions are fulfilled.

58. The method of claim 51, further comprising receiving, from the wireless device, a request to perform the one or more uplink transmissions on the licensed uplink carrier or the unlicensed uplink carrier, and wherein said selecting is performed responsive to receiving the request.

59. The method of claim 58, wherein receiving the request comprises receiving:
a sounding reference signal on the licensed uplink carrier;
a physical uplink control channel transmission on the licensed uplink carrier;
a random access transmission on the licensed uplink carrier;
a medium access control (MAC) control element (CE) on the licensed uplink carrier; or
a radio resource control (RRC) message on the licensed uplink carrier.

60. The method of claim 51, further comprising:
for each channel, subband, or bandwidth part of the unlicensed uplink carrier, obtaining a measure of channel occupancy on and/or clear channel assessment failure on that channel, subband, or bandwidth part;
based on the measure of channel occupancy on and/or clear channel assessment failure on each channel, subband, or bandwidth part, selecting a channel, subband, or bandwidth part on which the wireless device is to perform one or more uplink transmissions; and
transmitting, to the wireless device, signaling indicating the selected channel, subband, or bandwidth part on which the wireless device is to perform the one or more uplink transmissions.

61. The method of claim 51, wherein the unlicensed uplink carrier is a New Radio (NR) unlicensed uplink carrier, and wherein the licensed uplink carrier is a supplementary uplink carrier.

62. A wireless device comprising:
communication circuitry; and
processing circuitry configured to:
obtain a measure of channel occupancy within and/or clear channel assessment failure within an unlicensed frequency band within which an unlicensed uplink carrier of a cell is deployed;
select, from among the unlicensed uplink carrier of the cell and a licensed uplink carrier of the cell, an uplink carrier on which to perform one or more uplink transmissions, based on the obtained measure, wherein the measure is a function of channel occupancy on and/or clear channel assessment failure on the unlicensed uplink carrier; and
perform the one or more uplink transmissions on the selected uplink carrier.

63. A network node comprising:
communication circuitry; and
processing circuitry configured to:
obtain a measure of channel occupancy within and/or clear channel assessment failure within an unlicensed frequency band within which an unlicensed uplink carrier is deployed;
select, from among the unlicensed uplink carrier of the cell and a licensed uplink carrier of the cell, an uplink carrier on which a wireless device is to perform one or more uplink transmissions, based on the obtained measure, wherein the measure is a function of channel occupancy on and/or clear channel assessment failure on the unlicensed uplink carrier; and
transmit, to the wireless device, signaling indicating the selected uplink carrier on which the wireless device is to perform the one or more uplink transmissions.
